(19) United States
(12) Patent Application Publication
(10) Pub. No.: US 2018/0299285 A1
(43) Pub. Date: Oct. 18, 2018

(54) SERVER DEVICE, VEHICLE CONTROL DEVICE, AND COMMUNICATION DEVICE

(71) Applicant: KYOCERA CORPORATION, Kyoto (JP)

(72) Inventor: Kugo MORITA, Yokohama-shi (JP)

(73) Assignee: KYOCERA CORPORATION, Kyoto (JP)

(21) Appl. No.: 16/015,226

(22) Filed: Jun. 22, 2018

Related U.S. Application Data
(63) Continuation of application No. PCT/JP2016/088565, filed on Dec. 22, 2016.
(60) Provisional application No. 62/387,332, filed on Dec. 23, 2015.
(60) Provisional application No. 62/387,336, filed on Dec. 23, 2015.

(51) Int. Cl. G01C 21/34; G06F 17/30

(52) U.S. Cl. CPC G01C 21/3492; G06F 17/30241; G01C 21/3461

(57) ABSTRACT

A server device according to one embodiment performs communication with a plurality of vehicles having an automatic driving function through a network. The server device comprises a processing unit configured to assign a road area along a traveling route of the vehicle for each predetermined period and for each of the vehicles included in the plurality of vehicles. The road area is an area to be occupied by the vehicle on a road within the predetermined period. The processing unit notifies each of the vehicles of the road area so that each vehicle travels by automatic driving according to the road area assigned to the vehicle.

### CROSS-REFERENCE TO RELATED APPLICATION

The present application is a continuation based on PCT Application No. PCT/JP2016/088565 filed on Dec. 22, 2016, which claims the benefit of U.S. Patent Provisional Application No. 62/387332 (filed on Dec. 23, 2015) and U.S. Patent Provisional Application No. 62/387336 (filed on Dec. 23, 2015), the entire contents of which are incorporated herein by reference.

### FIELD

The present invention relates to a server device, a vehicle control device, and a communication device for a road transportation system.

### BACKGROUND

Driving of an automobile is basically carried out by using an accelerator, a brake, and a steering wheel. A driver drives an automobile by controlling them. When considering traveling to a destination to which you are going for the first time, the driver has conventionally confirmed and memorized a route to the destination on a map in advance, and then performed driving to the destination based on the memory. Alternatively, a driver had a passenger see a map, and drove to a destination according to the instructions of the passenger.

On the other hand, at present, a driver can drive to a destination according to instructions of a navigation system (see Patent Literature 1: JP 6-194181 A). The navigation system searches for a route to a destination set in advance on map data, which is converted into digital data, from current position information acquired by a position information acquisition means such as a Global Navigation Satellite System (GNSS). Based on the search result, the navigation system sequentially issues an instruction corresponding to the current position to the driver. The driver can arrive at the destination by driving according to the instruction. Therefore, the driver can arrive at the destination, without spending effort to grasp the driving route in advance or without a passenger who has to spend effort to check the map and give the instruction.

However, until now, it was necessary for a person having a driving skill to board a vehicle in the first place. Regarding this problem, recent research has been actively conducted on automatic driving (see Non Patent Literature 1: Shinomura Rinko “DI-1-2 Recent Trends in Automatic Driving and Driving Assist Technology” 2014 The Institute of Electronics, Information and Communication Engineers General Convention).

The automatic driving is a technique for autonomously driving a vehicle to a destination by successively grasping circumstances of the vehicle by various sensors such as a radar and/or a camera mounted on the vehicle, without intervention of a human's hand. In this manner, the passenger can move to the destination simply by setting the destination, without requiring the effort of the act of driving itself, and furthermore, without requiring the effort of learning the driving skill.

On the other hand, there is traffic congestion as a problem in road traffic. There are various causes of traffic congestion, for example, “traffic congestion (1) caused by a speed decreasing unintentionally as a result of keeping stepping on the same way without noticing a change to an uphill road”, “traffic congestion (2) where a vehicle (right turn vehicle) attempting to make a right turn is blocked by an oncoming vehicle and waits for a right turn, and a following vehicle of the right turn vehicle cannot pull out the right turn vehicle”, “traffic congestion (3) due to signal waiting”, “traffic congestion (4) caused by temporary concentration of vehicles on narrow roads”, and the like. As a mechanism of occurrence of such traffic congestion, it is considered that traffic congestion is caused by a decrease or stop of the speed of the vehicle traveling at the head due to some causes.

The above-mentioned traffic congestion (1) is a traffic congestion caused because the driver did not notice the change of situation due to visual misrecognition and operated as before. Therefore, in automatic driving that drives while checking a vehicle speed at any time, there is a possibility that traffic congestion (1) will be reduced.

On the other hand, at present, road conditions are collected with vehicle sensors installed on the roadside, and road information such as congestion based on this information is provided to each vehicle through FM multiplex broadcasting or road-to-vehicle communication such as beacon (VICS (registered trademark): Vehicle Information and Communication System). Each vehicle can select a route avoiding a congested road by considering the route to the destination based on the road information.

In addition, vehicle-to-vehicle (V2V) communication that directly transmits and receives information between vehicles has recently been studied. In the vehicle-to-vehicle communication, for example, it is thought that vehicle information such as the speed and position of the vehicle can be transmitted and received. Therefore, even if the speeds of some preceding vehicles are lowered for some reasons, it is possible to immediately receive information on the speed reduction from the preceding vehicles and warn the driver. Therefore, it is considered that the driver can respond to the speed reduction before the speed reduction of the immediately preceding vehicle occurs.

### SUMMARY

A server device according to one embodiment performs communication with a plurality of vehicles having an automatic driving function through a network. The server device comprises a processing unit configured to assign a road area along a traveling route of the vehicle for each predetermined period and for each of the vehicles included in the plurality of vehicles. The road area is an area to be occupied by the vehicle on a road within the predetermined period. The processing unit notifies each of the vehicles of the road area so that each vehicle travels by automatic driving according to the road area assigned to the vehicle.

A vehicle control device according to one embodiment is provided in a vehicle having an automatic driving function and controls the vehicle. The vehicle control device comprises a communication unit configured to perform communication with a server device through a network; and a processing unit configured to acquire, from the server device, assignment information indicating assignment of a road area along the traveling route of the vehicle. The road area is an area which is assigned from the server device for each predetermined period and is occupied by the vehicle on the road within the predetermined period. The processing unit performs processing for the vehicle to travel through an assigned road area of the vehicle by automatic driving, based on the assignment information.

A communication device according to one embodiments is provided in a vehicle. The communication device comprises: a communication unit configured to perform communication with a server device through a network. The communication unit acquires, from the server device, assignment information indicating assignment of a road area along a traveling route of the vehicle. The road area is an area which is assigned from the server device for each predetermined period and is occupied by the vehicle on a road within the predetermined period.

### BRIEF DESCRIPTION OF DRAWINGS

FIG. 1 is a configuration diagram according to an embodiment.

FIG. 2 is a diagram illustrating an example of a configuration of a vehicle according to an embodiment.

FIG. 3 is a diagram illustrating an example of a configuration of a route assignment server according to an embodiment.

FIG. 4 is a diagram illustrating an example of a configuration of a charging server according to an embodiment.

FIGS. 5A to 5D are diagrams illustrating examples of road assignment according to an embodiment.

FIGS. 6A to 6D are diagrams illustrating examples of route assignment information according to an embodiment.

FIG. 7 is a diagram illustrating an example of a flow of normal travel setting according to an embodiment.

FIG. 8 is a diagram illustrating an example of a flow of high-speed travel setting according to an embodiment.

FIGS. 9A to 9B are diagrams illustrating examples of normal travel setting according to an embodiment.

FIGS. 10A to 10B are diagrams illustrating examples of high-speed travel setting according to an embodiment.

FIGS. 11A to 11B are diagrams illustrating examples of high-speed travel setting according to an embodiment.

FIGS. 12A to 12B are diagrams illustrating conventional road use examples according to an embodiment.

FIGS. 13A to 13D are diagrams illustrating examples of road assignment according to an embodiment.

FIGS. 14A to 14D are diagrams illustrating an occupied area for each height according to an embodiment.

FIGS. 15A to 15B are diagrams illustrating conventional road use as comparative examples.

FIGS. 16A to 16B are diagrams describing road use according to an embodiment.

FIGS. 17A to 17B are diagrams illustrating examples of a camera for scanning a height according to an embodiment.

FIGS. 18A to 18B are diagrams illustrating examples of a camera for scanning a height according to an embodiment.

FIGS. 19A to 19B are diagrams illustrating road use according to an embodiment.

FIG. 20 is a processing flowchart of a vehicle of height scanning by a balance change according to an embodiment.

FIG. 21 is a processing flowchart of a route assignment server of height scanning by a balance change according to an embodiment.

FIG. 22 is a processing flowchart of a vehicle of height scanning at the time of opening a window according to an embodiment.

FIG. 23 is a processing flowchart of a route assignment server of height scanning at the time of opening a window according to an embodiment.

FIG. 24 is a flowchart of a route assignment server by vibration possibility according to an embodiment.

FIGS. 25A to 25B are examples of height occupied area processing when there is vibration possibility, according to an embodiment.

FIGS. 26A to 26B are flowcharts describing setting of a minute section according to an embodiment.

FIGS. 27A to 27B are diagrams illustrating reception of a synchronization reference signal according to an embodiment.

FIG. 28 is a configuration diagram according to a modification example.

FIG. 29 is a diagram illustrating an example of a configuration of a vehicle according to a modification example.

FIG. 30 is a diagram illustrating an example of a configuration of a route assignment server according to a modification example.

FIG. 31 is a diagram illustrating an example of a configuration of a weather information server according to a modification example.

FIG. 32 is a diagram illustrating an example of a flow of movement setting according to a modification example.

FIG. 33 is a diagram illustrating an example of a flow at the time of acquiring environmental information according to a modification example.

FIG. 34 is a diagram illustrating an example of a flow at the time of acquiring weather information according to a modification example.

FIG. 35 is a diagram illustrating an example of a flowchart of updating a vehicle information storage unit according to a modification example.

FIG. 36 illustrates an example of a flowchart in a vehicle body upon a driving request according to a modification example.

FIG. 37 illustrates an example of a flowchart in a route assignment server upon a driving request according to a modification example.

FIG. 38 illustrates an example of a processing flowchart in a vehicle at the time of measuring environmental information according to a modification example.

FIG. 39 illustrates an example of a processing flowchart of a route assignment server at the time of receiving environmental information and weather information according to a modification example.

FIG. 40 illustrates an example of a processing flowchart of a route assignment server at the time of updating a weather information storage unit according to a modification example.

FIGS. 41A to 41B are diagrams illustrating examples of setting of an occupied area by wind pressure according to a modification example.

FIGS. 42A to 42B are diagrams illustrating road use in the case of absence of wind pressure according to a modification example.

FIGS. 43A to 43B are diagrams illustrating road use in the case of presence of wind pressure according to a modification example.

FIGS. 44A to 44B are diagrams illustrating examples of setting of an occupied area by wind pressure according to a modification example.

FIGS. 45A to 45B illustrate examples of setting of occupied area by aged deterioration according to a modification example.

FIGS. 46A to 46B illustrate examples of setting of occupied area by bound according to a modification example.

FIGS. 47A to 47C illustrate examples of a setting of occupied area by a road surface condition according to a modification example.

FIGS. 48A to 48B illustrate examples of setting of occupied area in a curve according to a modification example.

FIGS. 49A to 49B are diagrams illustrating broadcasting of auxiliary position information according to a modification example.

FIGS. 50A to 50B are diagrams illustrating broadcasting of an auxiliary synchronization signal according to a modification example.

FIG. 51 is a diagram illustrating assignment of a radio communication scheme at the time of interrupting communication with a route assignment server according to a modification example.

FIG. 52 is a diagram illustrating assignment of a radio communication scheme at the time of enabling communication with a route assignment server according to a modification example.

### DESCRIPTION OF EMBODIMENTS

[Overview of Embodiments]

As described above, the automatic driving is a technique in which individual vehicles autonomously determine the surroundings based on information acquired by sensors held in the individual vehicles and perform driving. However, for example, in the case of the traffic congestion (2), the oncoming vehicle is not necessarily limited to the right turn vehicle. Even when there is the vehicle that gives way to the road, if the right turn vehicle cannot determine that a safe right turn is possible, the right turn vehicle will not turn to the right. Also, in the vehicle-to-vehicle communication, even when one oncoming vehicle urges the right turn to the right turn vehicle, if another oncoming vehicle makes a different determination, the right turn vehicle cannot determine that a safe right turn is possible and does not turn to the right. For example, in the case of the traffic congestion (4), when avoiding the traffic congestion based on traffic congestion information by the road-to-vehicle communication, the respective vehicles perform traffic congestion avoidance behaviors in the same way, and thus the traffic congestion place moves to another place. Therefore, even in the automatic driving, it can be said that there is a problem of traffic congestion.

On the other hand, when considering the passage of an emergency vehicle such as an ambulance, no matter how heavy traffic, each vehicle makes the way to pass the emergency vehicle, and thus the emergency vehicle passes even in the traffic congestion. This means that there is still room on the road, and if a space can be used more effectively, there is a possibility of providing a more comfortable driving environment. In other words, in a current road use, there is a problem that the space cannot be used sufficiently efficiently.

A server device (route assignment server 200) according to embodiments performs communication with a plurality of vehicles (vehicle 100) having an automatic driving function through a network (network 500). The server device comprises a processing unit (processing unit 202) configured to assign a road area along a traveling route of the vehicle for each predetermined period and for each of the vehicles included in the plurality of vehicles. The road area is an area to be occupied by the vehicle on a road within the predetermined period. The processing unit notifies each of the vehicles of the road area so that each vehicle travels by automatic driving according to the road area assigned to the vehicle.

If each of the vehicles has a priority, the processing unit may assign the road area in the order of a vehicle having a higher priority to a vehicle having a lower priority. The processing unit may perform charging for each of the vehicles according to the priority, based on the assignment result of the road area based on the priority.

The processing unit may acquire, from the vehicle, measurement information obtained by one sensor or a plurality of sensors provided in the vehicle. The measurement information may include information indicating an occupied area for each height from a road surface. The occupied area may be an area occupied by the vehicle in a space on the road. The processing unit may assign the road area to the vehicle based on the measurement information so that the vehicle does not come in contact with another vehicle.

In the server device according to the embodiments, the processing unit may determine whether to continue traveling in the vehicle based on the measurement information. If the processing unit determines that the vehicle does not continue traveling, the processing unit may perform processing for stopping the vehicle at a predetermined position.

In the server device according to the embodiments, the processing unit may estimate the occupied area when the vehicle travels on the road, based on information about the vehicle and/or information about the road.

In the server device according to the embodiments, the processing unit may acquire, from the vehicle, position information indicating a position of the vehicle and synchronization information indicating synchronization accuracy at the position. The synchronization accuracy may be determined according to a type of a signal source that is a synchronization source and/or reception strength from the signal source. The processing unit may determine a length of the predetermined period to be applied to each of the vehicles existing at the position and around the position, based on the synchronization accuracy.

In the server device according to the embodiments, the processing unit may notify the vehicle of information designating the signal source and a correction value for correcting a synchronization timing synchronized with the synchronization source.

In the server device according to the embodiments, the processing unit may assign the road area to the vehicle, based on at least one of vehicle information indicating a state of the vehicle or components of the vehicle, weather information about weather in the area where the vehicle is located, measurement information obtained by measuring the state of the vehicle by the vehicle, and environmental information obtained by measuring the surroundings of the vehicle by the vehicle.

In the server device according to the embodiments, the vehicle information may include at least one of a model number, a use start date, a use time, and a repair history of the vehicle or the components of the vehicle.

In the server device according to the embodiments, the weather information may include at least one of weather forecast, weather warning/caution, typhoon information, flood information, sediment disaster information, tornado information, tsunami information, earthquake information, and eruption information.

In the server device according to the embodiments, the measurement information may include at least one of a weight, a center of gravity, a balance, an occupied area for each height, and an opened/closed state of a window.

In the server device according to the embodiments, the environmental information may include information indicating a state of atmosphere and/or a state of a road surface. The atmospheric state may include at least one of temperature, pressure, humidity, wind direction, wind pressure, rain, snow, hail, and fog. The state of the road surface may include at least one of unevenness on the road surface, drying, flooding, snow covering, freezing, falling objects, and breakage.

In the server device according to the embodiments, the processing unit may notify at least one of the vehicle, a base station, and a base station control device of a radio communication parameter used by the vehicle to notify the server device of the measurement information and/or the environmental information, and position information indicating a position to which the radio communication parameter is to be applied.

In the server device according to the embodiments, the processing unit may estimate a road environment at the time of traveling of the vehicle, based on the weather information and/or the environmental information. The processing unit may estimate a safety degree of the road corresponding to the traveling route based on the road environment. The processing unit may change at least one of the traveling routes, the road area, and the priority of the vehicle based on the safety degree.

In the server device according to the embodiments, if the processing unit determines that an evacuation instruction is issued based on the weather information, the processing unit may instruct at least one vehicle existing in a area corresponding to the evacuation instruction and/or surroundings of the area to operate as an evacuation/rescue vehicle.

In the server device according to the embodiments, if the processing unit determines that the evacuation instruction is issued based on the weather information, the processing unit may perform processing for checking a road condition corresponding to the evacuation instruction.

In the server device according to the embodiments, the processing unit may monitor a road surface condition based on the environmental information. The processing unit may assign the road area to the vehicle based on the road surface condition so that the vehicle travels on a flat road surface and/or the vehicle travels avoiding a road damage area.

In the server device according to the embodiments, the processing unit may estimate a road environment at the time of traveling of the vehicle, based on the weather information and/or the environmental information. The processing unit may estimate accuracy of a travel control of the vehicle and/or accuracy of a position measurement of the vehicle based on at least one of the road environment, the measurement information, and the vehicle information. The processing unit may estimate an occupied area which is an area occupied by the vehicle in the space on the road, based on the estimated accuracy.

In the server device according to the embodiments, if the processing unit determines that there is an area where measurement accuracy of the position deteriorates, based on the weather information and/or the environmental information, the processing unit may select a position reference vehicle as a reference of position measurement. The processing unit may instruct the position reference vehicle to notify auxiliary position information used for position calculation by surrounding vehicles.

In the server device according to the embodiments, if the processing unit determines that there is a possibility that a base station serving as a synchronization source will be stopped, based on the weather information and/or the environmental information, the processing unit may select a synchronous reference vehicle from the vehicles related to a service providing area of the base station. The processing unit may instruct the synchronous reference vehicle to broadcast an auxiliary synchronization signal used for synchronization processing by surrounding vehicles.

In the server device according to the embodiments, if the processing unit determines that there is a possibility that a radio communication network will be interrupted, based on the weather information and/or the environmental information, the processing unit may previously notify each of the vehicles of a plurality of traveling routes.

In the server device according to the embodiments, each of the plurality of traveling routes may have a route number common to the entire vehicles.

In the server device according to the embodiments, if the processing unit determines that there is a possibility that a radio communication network will be interrupted, based on the weather information and the environmental information, the processing unit may previously notify each of the vehicles of radio communication parameters to be used for each section included in the traveling route.

A vehicle control device (vehicle control device 100b) according to the embodiments is provided in a vehicle (vehicle 100) having an automatic driving function and controls the vehicle. The vehicle control device comprises a communication unit (communication unit 102) configured to perform communication with a server device (route assignment server 200) through a network (network 500); and a processing unit (communication unit 102, processing unit 103, automatic driving processing unit 110) configured to acquire, from the server device, assignment information indicating assignment of a road area along the traveling route of the vehicle. The road area is an area which is assigned from the server device for each predetermined period and is occupied by the vehicle on the road within the predetermined period. The processing unit performs processing for the vehicle to travel through an assigned road area of the vehicle by automatic driving, based on the assignment information.

In the vehicle control device according to the embodiments, the processing unit may notify the server device of measurement information obtained by a sensor provided in the vehicle. The measurement information may include information indicating an occupied area for each height from a road surface. The occupied area may be an area occupied by the vehicle in a space on the road.

In the vehicle control device according to the embodiments, the processing unit may notify the server device of position information indicating a position of the vehicle and synchronization information indicating synchronization accuracy at the position. The synchronization accuracy may be determined according to a type of a signal source that is a synchronization source and/or reception strength from the signal source.

In the vehicle control device according to the embodiments, the processing unit may acquire, from the server device, information designating the signal source and a correction value for correcting a synchronization timing synchronized with the synchronization source.

In the vehicle control device according to the embodiments the processing unit may notify the server device of at least one of vehicle information indicating a state of the vehicle or components of the vehicle, weather information about weather in the area where the vehicle is located, measurement information obtained by measuring the state of the vehicle by the vehicle, and environmental information obtained by measuring the surroundings of the vehicle by the vehicle.

In the vehicle control device according to the embodiments, the processing unit may acquire, from the server device, a radio communication parameter used by the vehicle to notify the server device of the measurement information and/or the environmental information, and position information indicating a position to which the radio communication parameter is to be applied. The processing unit may perform radio communication with a base station by using the radio communication parameter corresponding to the position of the vehicle.

In the vehicle control device according to the embodiments, the processing unit may broadcast auxiliary position information used by surrounding vehicles for position calculation, in response to reception of an instruction from the server device to the effect that the vehicle should operate as a position reference vehicle serving as a reference of position measurement.

In the vehicle control device according to the embodiments, the processing unit may broadcast auxiliary synchronization signals used by surrounding vehicles for synchronization processing, in response to reception of an instruction from the server device to the effect that the vehicle should operate as a synchronization reference vehicle serving as a reference of synchronization.

In the vehicle control device according to the embodiments, in a case where a plurality of traveling routes each having a route number are notified from the server device, if the processing unit detects a traffic-impossible position, the processing unit may change from a traveling route including the traffic-impossible position to other traveling route. The processing unit may broadcast information about the traffic-impossible position and/or the route number of the other traveling route.

In the vehicle control device according to the embodiments, if a radio communication parameter to be used for each section included in the traveling route of the vehicle is notified from the server device, the processing unit may perform radio communication with a base station by using the radio communication parameter corresponding to the position of the vehicle.

A communication device (communication device 100a) according to the embodiments is provided in a vehicle (vehicle 100). The communication device comprises: a communication unit (communication unit 102) configured to perform communication with a server device (route assignment server 200) through a network (network 500). The communication unit acquires, from the server device, assignment information indicating assignment of a road area along a traveling route of the vehicle. The road area is an area which is assigned from the server device for each predetermined period and is occupied by the vehicle on a road within the predetermined period.

According to an embodiment, a server device assigns a road area occupied by a vehicle at predetermined intervals, and a vehicle travels in the assigned road area by automatic driving. Thus, it is possible to effectively utilize the space of the road and it is possible to realize a more comfortable driving environment.

### Embodiment

An embodiment will be described below.

(System Configuration)

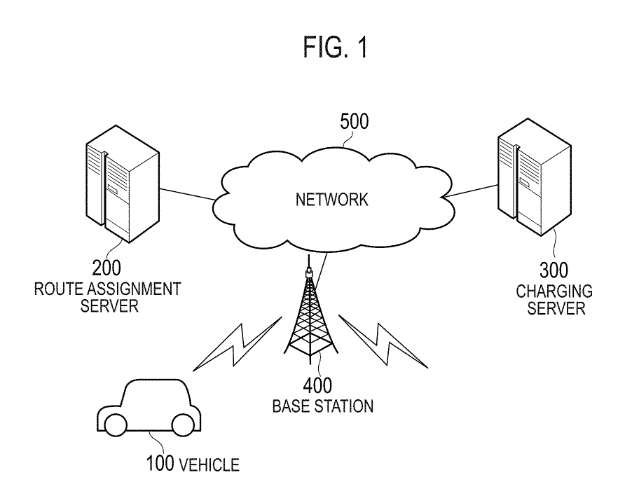

FIG. 1 is a diagram illustrating a configuration of a system according to an embodiment.

As illustrated in FIG. 1, a vehicle 100 radio-communicates with a base station 400. The base station 400, a route assignment server 200, and a charging server 300 communicate with one another through a network 500.

The vehicle 100 transmits a request for traveling (travel request) to the route assignment server 200 through the base station 400 and the network 500. The route assignment server 200 calculates the route assignment of each vehicle 100 based on the travel request of the vehicle 100 and the previously received travel request of another vehicle 100. The route assignment server 200 transmits the route assignment to each vehicle 100 as necessary. The vehicle 100 is a vehicle having an automatic driving function. The vehicle 100 travels by automatic driving according to the received route assignment.

Charging may be made for the route assignment. In this case, the route assignment server 200 determines whether charging is generated for a travel request from the vehicle 100. When the route assignment server 200 determines that the charging is generated, the route assignment server 200 notifies the vehicle 100 of that effect. The vehicle 100 notifies the route assignment server 200 of approval or rejection of the charging. If the notification of the vehicle 100 is the approval, the route assignment server 200 notifies the charging server 300 of the approval of the charging and fixes the route assignment.

(Configuration of Vehicle)

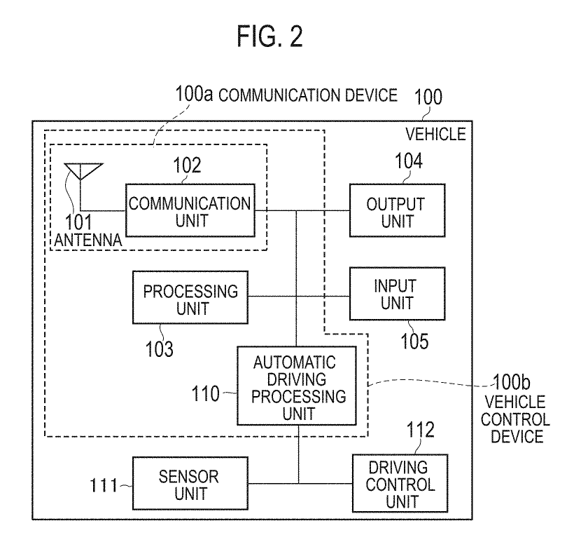

FIG. 2 is a diagram illustrating an example of the configuration of the vehicle 100 according to an embodiment.

As illustrated in FIG. 2, the vehicle 100 includes an antenna 101, a communication unit 102, a processing unit 103, an output unit 104, an input unit 105, an automatic driving processing unit 110, a sensor unit 111, and a driving control unit 112. The communication unit 102 is radio-connected to the base station 400 through the antenna 101. The output unit 104 outputs an image and/or a sound to passengers (a driver and a fellow passenger). The input unit 105 receives a voice input from a passenger and an operation input of a touch panel or the like. The automatic driving processing unit 110 performs processing in automatic driving. The sensor unit 111 includes a sensor for measurement outside the vehicle, such as a camera and a laser, and a sensor for measurement inside the vehicle, such as a vehicle speed, a position, and a weight. The driving control unit 112 controls the traveling of the vehicle 100 based on driving operations such as an accelerator, a brake, and a steering.

The antenna 101 and the communication unit 102 constitute a communication device 100a provided in the vehicle 100. The communication device 100a may further include a processing unit 103. The communication device 100a, the processing unit 103, and the automatic driving processing unit 110 constitute a vehicle control device 100b that controls the vehicle 100. The vehicle control device 100b may further include an output unit 104 and an input unit 105. The operation of the vehicle 100 described below is controlled by the vehicle control device 100b.

The passenger inputs, to the input unit 105, a request such as movement to a destination, air conditioning, or music. If the request is a travel request, the processing unit 103 transmits the travel request to the route assignment server 200 through the communication unit 102. In the case of a request other than the travel request, the processing unit 103 activates a corresponding function in the vehicle. The processing unit 103 receives a notification from the route assignment server 200 through the communication unit 102. When the notification is a notification related to automatic driving, the processing unit 103 notifies the automatic driving processing unit 110 of this notification. When the notification includes information that needs to be notified to the passenger, the processing unit 103 outputs the information to the passenger through the output unit 104.

The automatic driving processing unit 110 issues instructions for an accelerator, a brake, and a steering to the driving control unit 112, based on the information about the automatic driving received from the processing unit 103 and the acquisition result from the sensor unit 111, and controls the traveling of the vehicle 100. The automatic driving processing unit 110 notifies the processing unit 103 of a part or the whole of the measurement result acquired by the sensor unit 111. The processing unit 103 notifies a part of the measurement result, for example, a road surface condition and/or a vehicle body condition, to the route assignment server 200 through the communication unit 102.

The vehicle 100 is synchronized with a timing based on a signal from a GNSS and a signal from the base station 400. The vehicle 100 notifies the route assignment server 200 of the level and position of synchronization.

The vehicle 100 checks the position on the road based on the result of measuring the road by using the sensor together with the position information by the GNSS, and travels to the position designated by the route assignment server 200. When the road is measured by using the sensor, the vehicle 100 detects and grasps a painted line on the road, such as a shoulder, a median strip, or a white line, by using a camera and/or a distance sensor. Alternatively, at the time of creating the road, numerous magnetic substances are mixed into the asphalt or cement and spread on the road. The vehicle 100 stores a combination of magnetic substance arrangement pattern and position. At the time of traveling, the vehicle 100 reads the arrangement pattern of the magnetic substances around the lower portion of the vehicle body of the vehicle 100 by using the sensor. The vehicle 100 specifies the position thereof based on the read arrangement pattern.

(Configuration of Route Assignment Server)

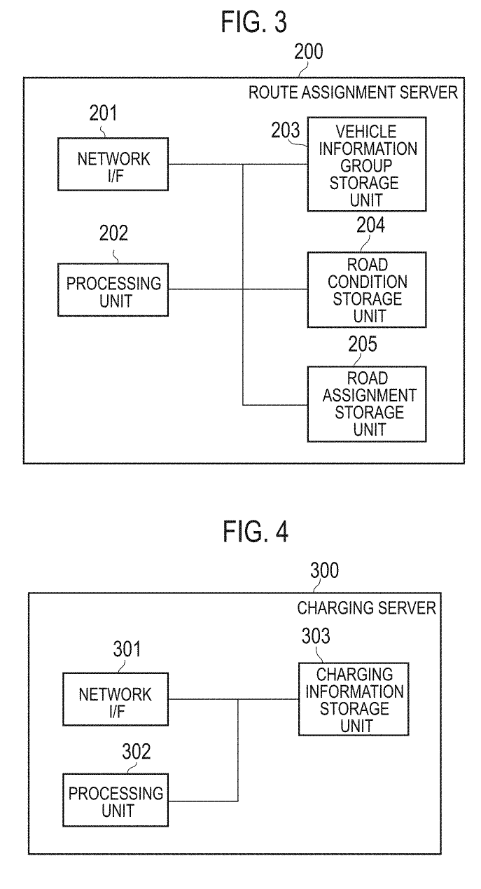

FIG. 3 is a diagram illustrating an example of the configuration of the route assignment server 200 according to an embodiment.

As illustrated in FIG. 3, the route assignment server 200 includes a network I/F unit 201, a processing unit 202, a vehicle information group storage unit 203, a road condition storage unit 204, and a road assignment storage unit 205. The network I/F unit 201 is connected so as to communicate with the network 500. The vehicle information group storage unit 203 stores information about each vehicle 100. The road condition storage unit 204 stores the road surface condition of the road and the like. The road assignment storage unit 205 stores the assignment of the road to the vehicle 100.

The processing unit 202 performs communication with the vehicle 100 and the charging server 300 through the network I/F unit 201. The processing unit 202 stores, in the vehicle information group storage unit 203, the travel request and/or the vehicle body condition from the vehicle 100. The processing unit 202 stores, in the road condition storage unit 204, the road surface condition from the vehicle 100 and/or a road management device disposed on the road side.

The processing unit 202 performs the assignment of the road based on the information held in the vehicle information group storage unit 203 and the information held in the road condition storage unit 204. The processing unit 202 stores the road assignment result (road assignment) in the road assignment storage unit 205. The processing unit 202 notifies the vehicle 100 of the road assignment in the vehicle 100 through the network I/F 201. The road assignment is route assignment information (road assignment information) composed of a road area assigned to only one vehicle 100 in a minute period (minute time period). The minute period is a period (for example, 1 ms) that becomes controllable based on the synchronization of the vehicle 100.

If there is a priority in the vehicle, the processing unit 202 first assigns the road area occupied in each minute period with respect to the traveling route of the vehicle 100 with high priority. In the case of vehicles having the same priority, the processing unit 202 compares the traveling routes of the respective vehicles 100. As a result of the comparison, if the vehicle travels on the same route section, the processing unit 202 assigns the road area occupied in each minute period from the vehicle 100 traveling ahead in time on the same route.

The route assignment server 200 (processing unit 202) determines a minute period of the position based on the accuracy of synchronization corresponding to the position acquired from the vehicle 100. The accuracy of the synchronization timing if the broadcast signal of the base station 400 can be received is different from the accuracy of the synchronization timing if only the GNSS can be received. For example, in the case based on the broadcast signal of the base station 400, the route assignment server 200 sets the minute period to be small (for example, 1 ms). On the other hand, in the case based on only the GNSS, the route assignment server 200 sets the minute period to be large (for example, 1 sec). If the length of the minute period is switched, the route assignment server 200 sets the length of the minute period to gradually change.

(Configuration of Charging Server)

FIG. 4 is a diagram illustrating an example of the configuration of the charging server 300 according to an embodiment.

As illustrated in FIG. 4, the charging server 300 includes a network I/F unit 301, a processing unit 302, and a charging information storage unit 303. The network I/F unit 301 is connected to communicate with the network 500. The charging information storage unit 303 stores charging information about the vehicle 100.

The processing unit 302 receives a charging approval message through the network I/F 301. The processing unit 302 holds the charging approval message in the charging information storage unit 303. In addition, the processing unit 302 receives a message of performance information indicating that the payment of the charging has been fulfilled. The processing unit 302 determines the charging according to the message contents of the performance information corresponding to the charging information in the charging information storage unit 303. The processing unit 302 performs the processing of the information of the charging information storage unit 303 based on the payment request.

(Example of Road Assignment)

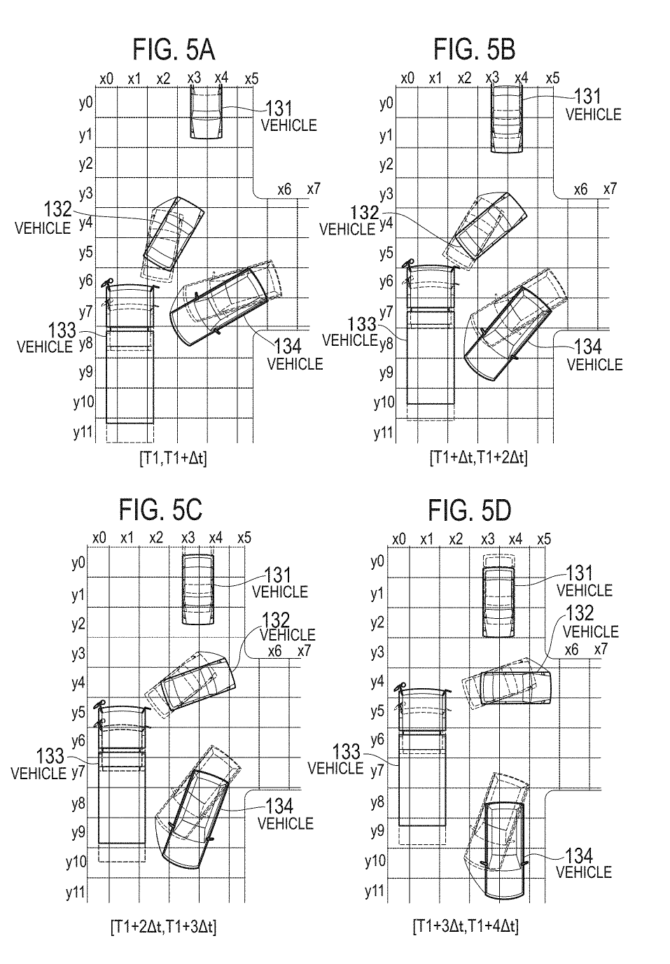

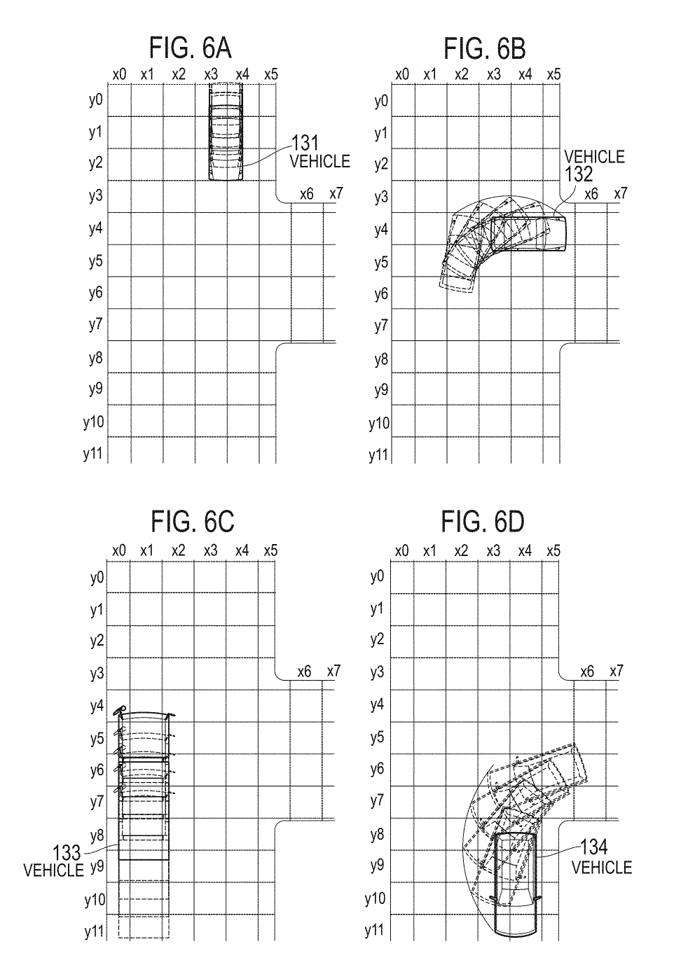

FIGS. 5A to 5D are diagrams illustrating examples of road assignment in the route assignment server 200. FIGS. 6A to 6B illustrate examples of route assignment information. In FIGS. 5A to 5D and FIGS. 6A to 6B, vehicles denoted by the same reference signs mean the same vehicle.

FIG. 5A illustrates the road assignment of the time interval [T1, T1+Δt], FIG. 5B illustrates the road assignment of the time interval [T1+Δt, T1+2Δt], FIG. 5C illustrates the road assignment of the time interval [T1+2Δt, T1+3Δt], and FIG. 5D illustrates the road assignment of the time interval [T1+3Δt, T1+4Δt]. FIGS. 6A to 6D illustrate route assignment information of a vehicle 131, a vehicle 132, a vehicle 133, and a vehicle 134 in the time interval [T1, T1+4Δt], respectively. For the sake of explanation, x0, x1, x2 . . . are denoted on a horizontal axis and y0, y1, y2 . . . are denoted on a vertical axis, so that the road area on the road can be known. At is, for example, 1 ms.

As illustrated in FIGS. 5A-5D, the vehicle 131 goes straight in a direction from y0 to y11. The vehicle 132 is making a right turn. The vehicle 133 is located at the rear of the vehicle 132 and goes straight in a direction from y11 to y0. The vehicle 134 is making a left turn. The road area occupied by all or part of the vehicle 132 in the time interval [T1, T1+Δt] is {(x2, y3), (x2, y4), (x2, y4), (x3, y4), (x1, y5), (x2, y5), (x3, y5), (x1, y6), (x2, y6)}. In the road area (x2, y6), the vehicle 132 and the vehicle 133 are assigned so as not to overlap each other. The vehicle 133 is traveling behind the vehicle 132. The vehicle 133 goes straight so that the road areas occupied by the vehicle 132 in the time interval [T1+Δt, T1+2Δt] and the time [T1+2Δt, T1+3Δt] do not overlap each other. The vehicle 131 is an oncoming vehicle of the vehicle 132. The vehicle 131 sets the road area occupied so as not to overlap the road area occupied by the vehicle 132 in the right turn operation. The vehicle 134 performs a left turn operation according to the right turn operation of the vehicle 132. In each time interval, no contact between the vehicles is ensured by performing the assignment so that the road area occupied by each vehicle does not overlap the road area occupied by other vehicles. Since the route assignment server 200 collectively performs the road assignment of each vehicle, smooth traveling can be realized without traffic signals even in the cases including the right turn and the left turn as illustrated in FIGS. 5A-5D.

FIG. 6A illustrates route assignment information in the time interval [T1, T1+4Δt] of the vehicle 131. The vehicle 131 occupies a part of the road areas {(x3, y0), (x4, y0), (x3, y1), (x4, y1), (x3, y2), (x4, y2)}. The vehicle 131 acquires the route assignment information and occupies only the designated road area at the unit time Δt. For example, in the time interval [T1, T1+Δt], only the designated area in the road areas {(x3, y0), (x4, y0), (x3, y1), (x4, y1)} is occupied based on the route assignment information in FIG. 6(a).

FIG. 6B illustrates route assignment information in the time interval [T1, T1+4Δt] of the vehicle 132. FIG. 6C illustrates route assignment information in the time interval [T1, T1+4Δt] of the vehicle 133. FIG. 6D illustrates route assignment information in the time interval [T1, T1+4Δt] of the vehicle 134. Based on each route assignment information, each vehicle occupies only the area designated by the route assignment information in a certain time interval.

As described above, the route assignment server 200 assigns the routes of all the vehicles 100, and the occupied areas of the respective vehicles 100 in each minute interval (for example, 1 ms) are determined. Each vehicle 100 can travel without contact with other vehicles by traveling only the occupied area assigned to each vehicle 100 according to the route assignment information for a predetermined time period.

(Example of Flow of Movement Setting)

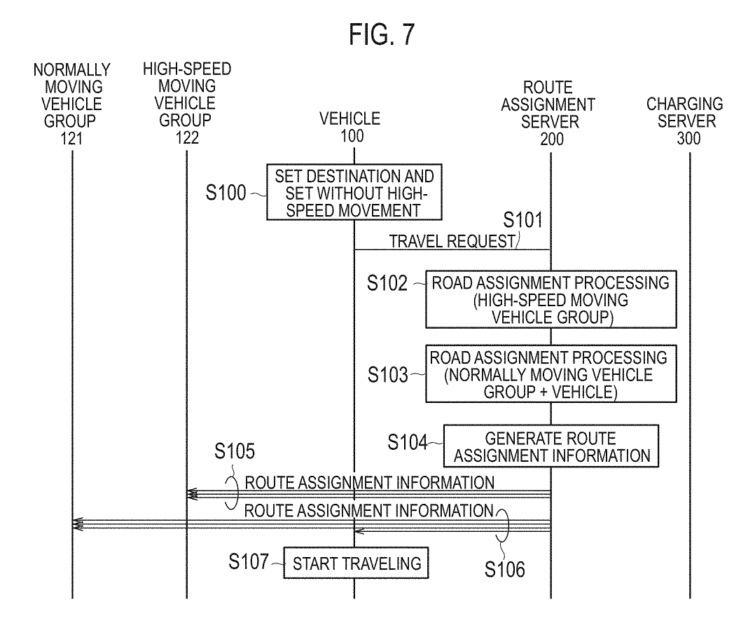

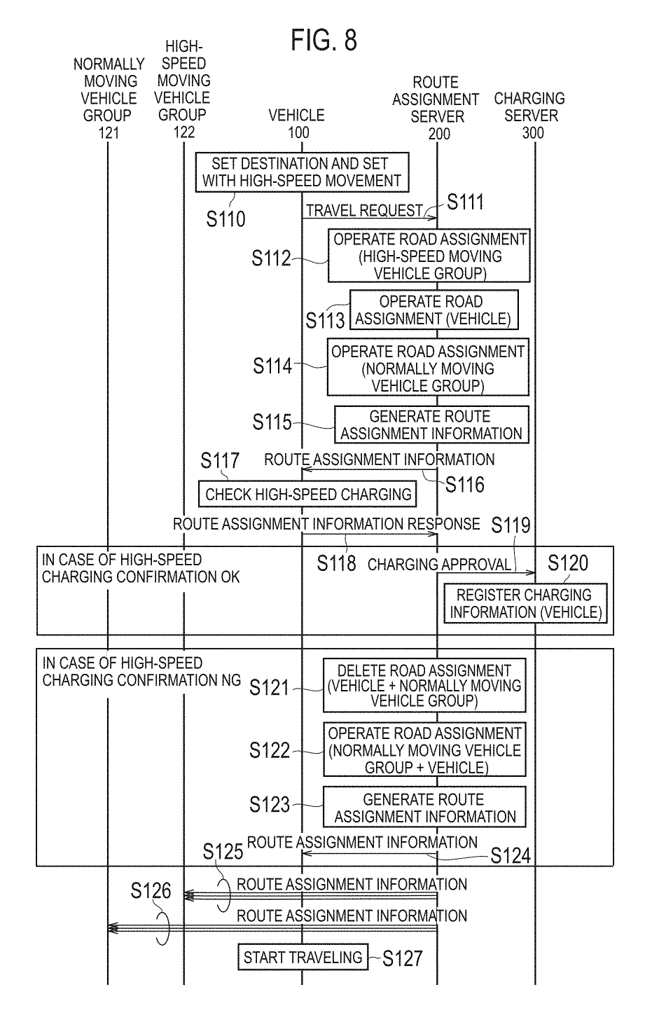

FIG. 7 is a diagram illustrating an example of a flow of normal movement setting. FIG. 8 illustrates an example of a flow of high-speed movement setting. The vehicles traveling on the road are classified into normally moving vehicles and high-speed moving vehicles. The normally moving vehicle is a vehicle that pays only the charging that is originally required for traveling on the road. The high-speed moving vehicle is a vehicle that is allowed to travel faster than the normally moving vehicle by paying an additional charging in addition to the charging that is originally required for traveling on the road. As illustrated in FIGS. 7 and 8, the normally moving vehicle group 121 is a group of vehicles for which the normal movement setting has already been fixed. The high-speed moving vehicle group 122 is a group of vehicles that have already fixed high-speed movement setting.

As illustrated in FIG. 7, it is assumed that the vehicle 100 performs normal movement setting. In the vehicle 100, the passenger operates the input unit 105 to set a destination and set no high-speed movement (step S100). The vehicle 100 notifies the route assignment server 200 of such a set request as a travel request (step S101). The route assignment server 200 performs road assignment processing on the high-speed moving vehicle group 122 based on the travel request (step S102). The route assignment server 200 performs the road assignment processing of the normally moving vehicle group 121 and the vehicle 100 (step S103). The route assignment server 200 generates route assignment information of each vehicle (step S104). The route assignment server 200 notifies the route assignment information to the high-speed moving vehicle group 122 (step S105). The route assignment server 200 notifies the route assignment information to the normally moving vehicle group 121 and the vehicle 100 (step S106). The vehicle 100 starts traveling by automatic driving based on the received route assignment information (step S107).

As illustrated in FIG. 8, it is assumed that the vehicle 100 performs high-speed movement setting. In the vehicle 100, the passenger operates the input unit 105 to set a destination and set high-speed movement (step S110). The vehicle 100 notifies the route assignment server 200 of such a set request as a travel request (step S111). The route assignment server 200 performs road assignment processing on the high-speed moving vehicle group 122 based on the travel request (step S112). The route assignment server 200 performs the road assignment processing of the vehicle 100 (step S113). The route assignment server 200 may temporarily include the vehicle 100 in the high-speed moving vehicle group 122 and perform the road assignment processing at once. The route assignment server 200 performs the road assignment processing of the normally moving vehicle group 121 (step S114). The route assignment server 200 generates route assignment information of each vehicle (step S115). The route assignment server 200 notifies the route assignment information to the vehicle 100 (step S116). The vehicle 100 outputs the received route assignment information through the output unit 104 to prompt the passenger to confirm the high-speed charging. The passenger inputs the high-speed charging confirmation OK/NG through the input unit 105 (step S117). The vehicle 100 transmits a route assignment information response including the high-speed charging confirmation to the route assignment server 200 (step S118).

If the high-speed charging confirmation of the route assignment information response is OK, the route assignment server 200 notifies a charging approval message to the charging server 300 (step S119). The charging server 300 stores the charging information including the notified message in the charging information storage unit 303 (step S120).

If the high-speed charging confirmation of the route assignment information response is NG, the route assignment server 200 determines that the vehicle 100 has changed to a non-charging movement setting and deletes the road assignment of each of the previously derived vehicle 100 and the normally moving vehicle group 121 (step S121). The route assignment server 200 performs the road assignment processing of the normally moving vehicle group 121 and the vehicle 100 (step S122). The route assignment server 200 generates route assignment information of each vehicle (step S123). The route assignment server 200 notifies the route assignment information to the vehicle 100 (step S124).

The route assignment server 200 notifies the route assignment information to the high-speed moving vehicle group 122 (step S125). The route assignment server 200 notifies the route assignment information to the normally moving vehicle group 121 (step S126). The vehicle 100 starts traveling based on the received route assignment information (step S127).

(Example of Movement Setting)

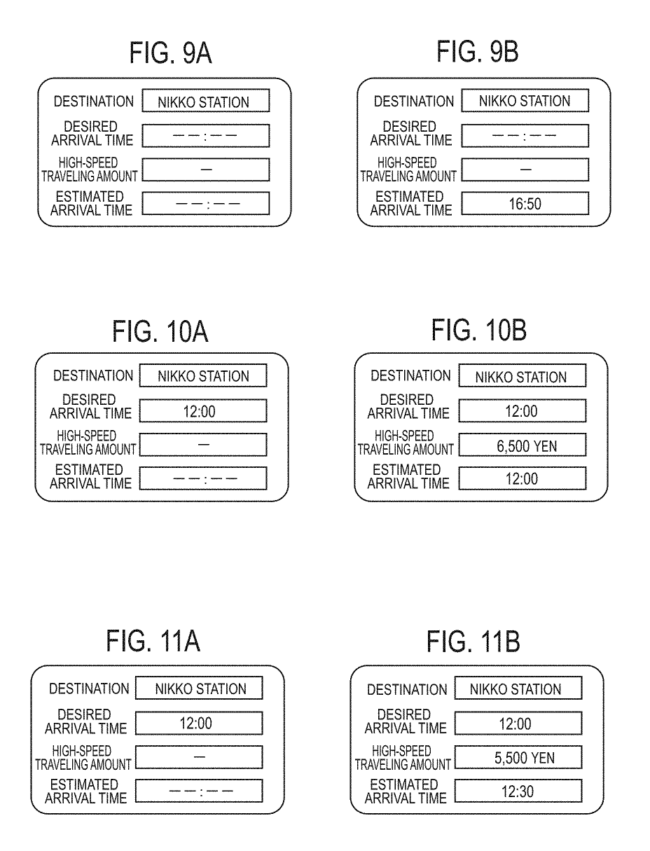

FIGS. 9A to 9B are diagrams illustrating examples of normal movement setting. FIGS. 10A to 10B are diagrams illustrating examples of high-speed movement setting. FIGS. 11A to 11B are diagrams illustrating other examples of high-speed movement setting. FIGS. 9A, 10A and 11A illustrate screens when the travel request is set by the passenger. FIGS. 9B, 10B and 11B illustrate screens on which the route assignment information processed by the route assignment server 200 based on the travel request is displayed and output to the passenger. The input to the input unit 105 of the vehicle 100 may be an input using voice recognition or an input by a touch panel, and other input devices may be used. Similarly, the output by the output unit 104 of the vehicle 100 may be a sound output or a screen output, and other output devices may be used. A combination thereof may be used.

As illustrated in FIGS. 9A to 9B, the passenger inputs Nikko station as the destination and requests traveling (FIG. 9A). The route assignment server 200 receives the travel request. Since the desired arrival time is not set in the travel request, the route assignment server 200 determines that it is the normal movement setting. The vehicle 100 receives the route assignment information. The vehicle 100 (the output unit 104) displays only the estimated arrival time as a result of the route assignment information (FIG. 9B).

As illustrated in FIGS. 10A-10B, the passenger inputs Nikko station as the destination, inputs 12:00 as the desired arrival time, and request traveling (FIG. 10A). The route assignment server 200 receives the travel request. Since the desired arrival time has been input, the route assignment server 200 determines that it is the high-speed movement setting. The vehicle 100 receives the route assignment information. As a result of the route assignment information, the vehicle 100 (the output unit 104) displays a high-speed traveling amount of 6,500 yen and an expected arrival time of 12:00 (FIG. 10B).

As illustrated in FIGS. 11A-11B, as in FIGS. 10A-10B, the passenger inputs Nikko station as the destination, inputs 12:00 as the desired arrival time, and request traveling (FIG. 11A). The route assignment server 200 receives the travel request. Since the desired arrival time has been input, the route assignment server 200 determines that it is the high-speed movement setting. The vehicle 100 receives the route assignment information. As a result of the route assignment information, the vehicle 100 (the output unit 104) displays a high-speed traveling amount of 5,500 yen and an expected arrival time of 12:30 (FIG. 11B). Since the estimated arrival time cannot be satisfied with respect to the desired arrival time, the vehicle 100 presents a high-speed traveling amount corresponding to the estimated arrival time.

(Example of Road Assignment)

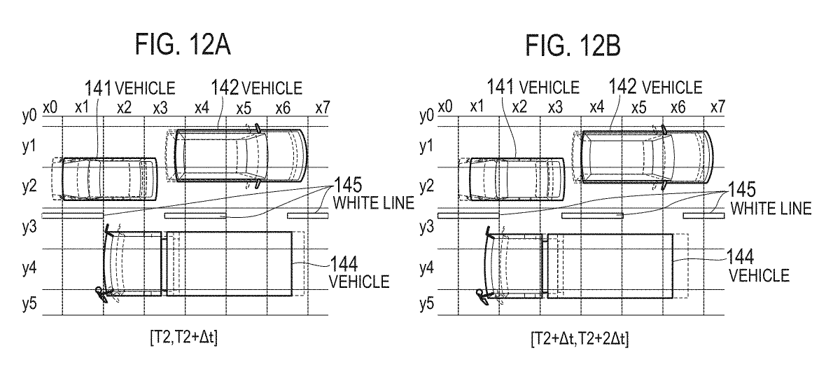

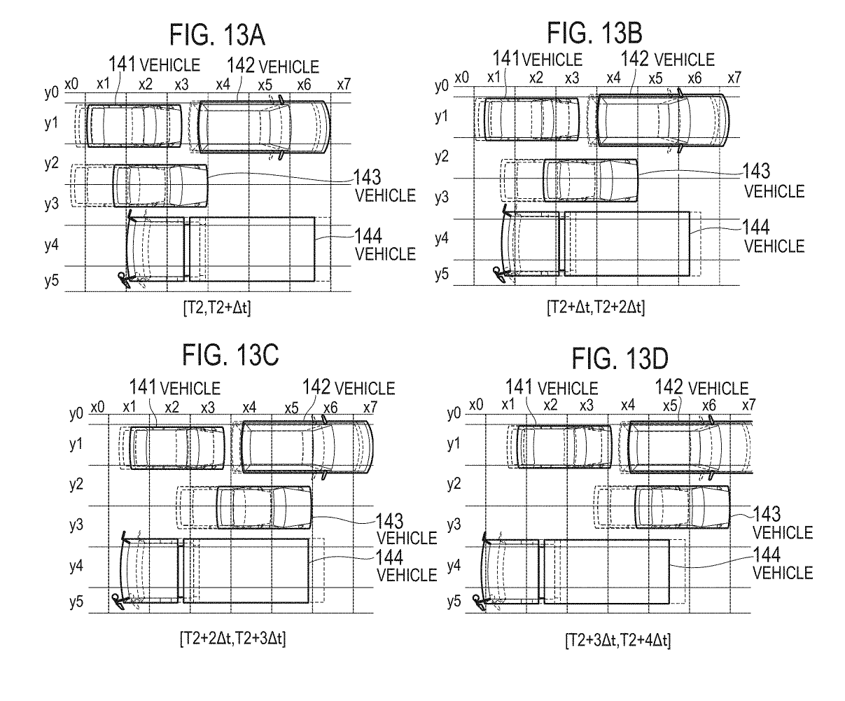

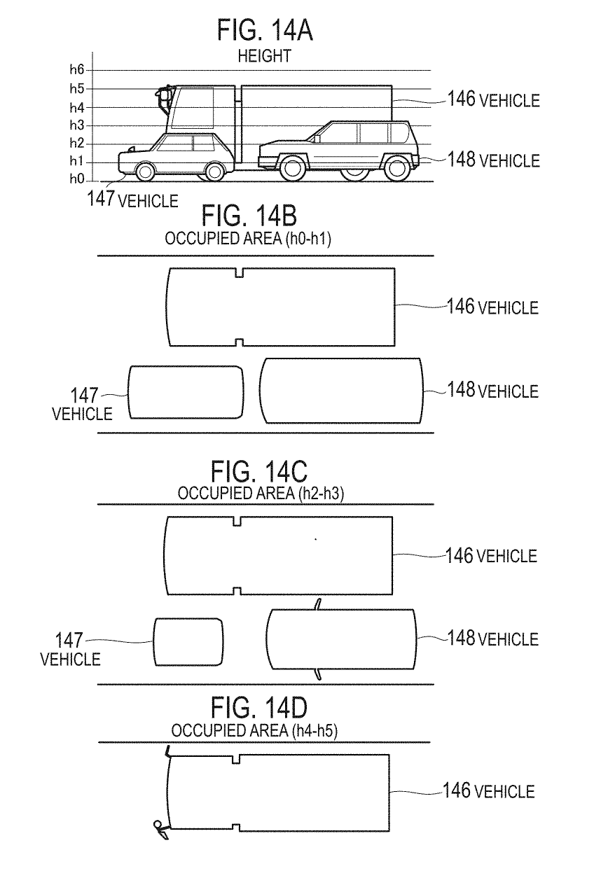

FIGS. 12A-12B illustrate conventional road use examples as comparative examples. FIGS. 13A-13D illustrate examples of road assignment information. FIG. 12A and FIG. 13A illustrate the road assignment of the time interval [T2, T2+Δt]. FIG. 12B and FIG. 13B illustrate the road assignment of the time interval [T2+Δt, T2+2Δt]. FIG. 13C illustrates the road assignment of the time interval [T2+2Δt, T2+3Δt]. FIG. 13D illustrates the road assignment of the time interval [T2+3Δt, T2+4Δt]. For the sake of explanation, x0, x1, x2 . . . are denoted on a horizontal axis and y0, y1, y2 . . . are denoted on a vertical axis, so that the road area on the road can be known. The road width is the same in FIGS. 12A-12B and 13A-13D.

As illustrated in FIGS. 12A-12B, as a conventional road use, roads are segmented at a center line such as a white line 145, and the vehicles travel in cascade in a determined direction for each of the divided roads. For example, the vehicle 141 travels toward the center line in the segmented road, and the vehicle 142 travels toward the roadside zone. In addition, the width of the vehicle 141 is narrower than that of the vehicle 144. The width of the road is determined so that the vehicle can travel in the same manner in any vehicle width, and any vehicle is traveling in the segmented road.

As illustrated in FIGS. 13A-13D, the vehicle 141, the vehicle 142, and the vehicle 144 are traveling toward the roadside zone. This creates a space in the center of the road. In the formed space, the vehicle 143 is traveling at a faster speed than the vehicle 141 and the vehicle 142. Here, the vehicle 143 is a vehicle that has set the high-speed traveling setting. The vehicles 141 and 142 are vehicles that set the normal traveling setting. The route assignment server 200 assigns roads of all the vehicles, and the processing unit 103 and the automatic driving processing unit 110 control the traveling of the vehicle 100 according to the assignment, so that the road can be effectively utilized.

(Occupied Area for Each Height)

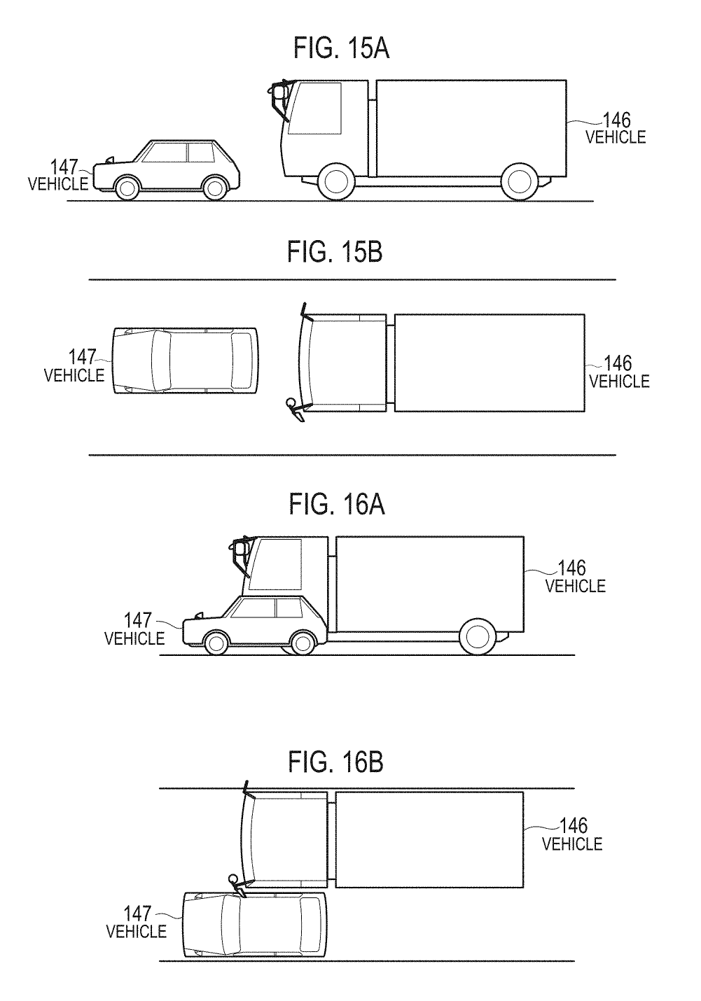

FIGS. 14A to 14D are diagrams illustrating a road area occupied for each height (occupied area). FIGS. 15A to 15B illustrate conventional road use as comparative examples. FIGS. 16A to 16B are diagrams illustrating road use according to the present embodiment. The roads in FIGS. 15A to 15B and 16A to 16B are one-way roads, and the widths of the roads are the same.

As illustrated in FIGS. 14A-14D, FIG. 14A is a view (side view) of a vehicle when seen from the side. FIG. 14B, FIG. 14C and FIG. 14D are views (top views) of a planar surface (cross-sectional surface) of a vehicle when viewed from the above. h0, h1, h2 . . . in FIG. 14A indicate the height from the road surface. FIG. 14B, FIG. 14C and FIG. 14D illustrate part of the occupied area for each height. FIG. 14B illustrates the occupied area of each vehicle at height h0 to h1. FIG. 14C illustrates the occupied area of each vehicle at the height h2 to h3. FIG. 14D illustrates the occupied area of each vehicle at the height h4 to h5.

A vehicle 147 and a vehicle 148 have a vehicle height lower than h4. Therefore, although the vehicle 147 and the vehicle 148 have occupied areas in FIG. 14B and FIG. 14C, there is no occupied area in FIG. 14D (h4 to h5). The vehicle 146 has a height of about h5. Therefore, the vehicle 146 has an occupied area in FIG. 14B, FIG. 14C, and FIG. 14D. The occupied area of the vehicle 148 has a substantially rectangular shape in FIG. 14B, but the occupied area in FIG. 14C has a shape in which a side mirror portion protrudes from the rectangular shape. The occupied area of the vehicle 146 has a substantially rectangular shape in FIG. 14B and FIG. 14C, but the occupied area in FIG. 14D has a shape in which the portion of the side mirror protrudes from the rectangular shape. In each of the vehicle 146 and the vehicle 148, it means that attention is paid to the protrusion of the side mirror portion at each height.

As illustrated in FIGS. 15A to 15B, FIG. 15A is a side view and FIG. 15B is a top view. The vehicle 147 and the vehicle 146 are traveling in cascade. In the case of the conventional road use, the vehicle 147 is traveling in the center of the road. Since there is not enough space on both sides of the vehicle 147, the vehicle 146 does not overtake the vehicle 147 but follows the vehicle 147.

As illustrated in FIGS. 16A to 16B, FIG. 16A is a side view and FIG. 16B is a top view. The vehicle 146 and the vehicle 147 are traveling in parallel. From FIG. 14D, the vehicle 147 has no occupied area. That is, it is sufficient to look at the occupied area at the height h0 to h3. Therefore, it seems from the top view of FIG. 16B that the side mirror of the vehicle 146 overlaps the upper side of the vehicle 147 and the upper side of the road side, but it can be seen from the side view of FIG. 16A that the side mirror of the vehicle 146 does not overlap the vehicle 147. Therefore, the vehicle 146 and the vehicle 147 can travel in parallel. As a result, the route assignment server 200 instructs the vehicle 146 and the vehicle 147 to travel in parallel.

From the above, in a case where only the area viewed from above is determined, if the vehicle 146 and the vehicle 147 are intended to travel in parallel, it is determined as the contact. However, it can be seen that a plurality of vehicles can travel in parallel without looking closely at the occupied areas for each height. In other words, by viewing the occupied area for each height, it becomes possible to use the road more effectively.

(Example of Sensor)

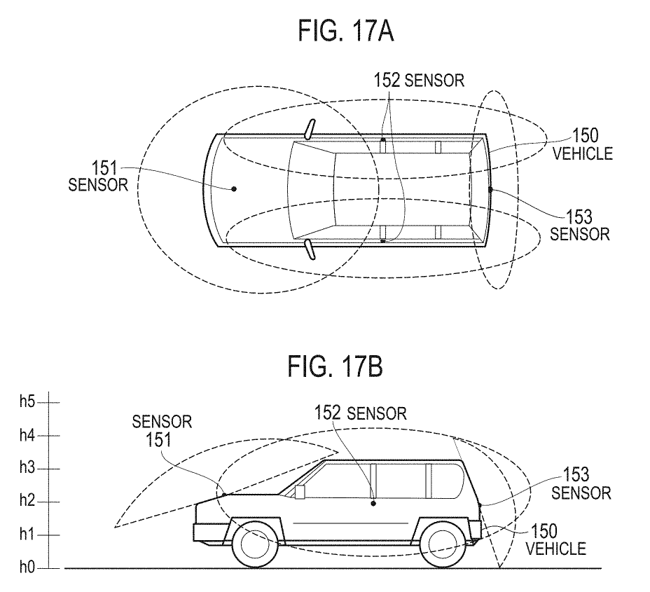

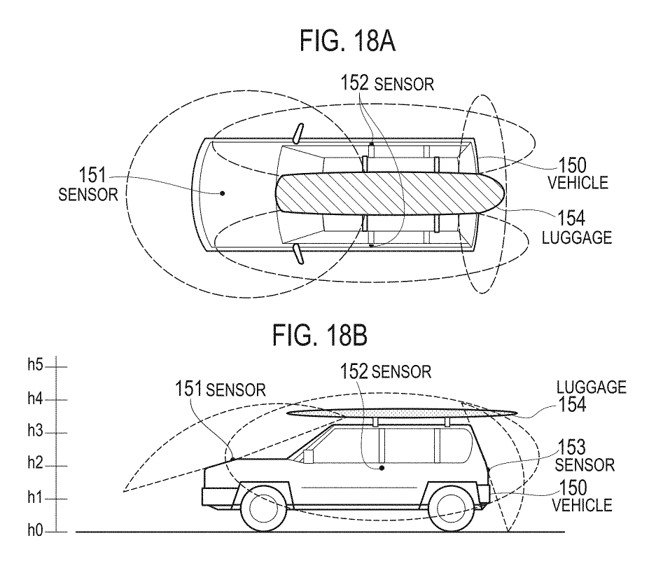

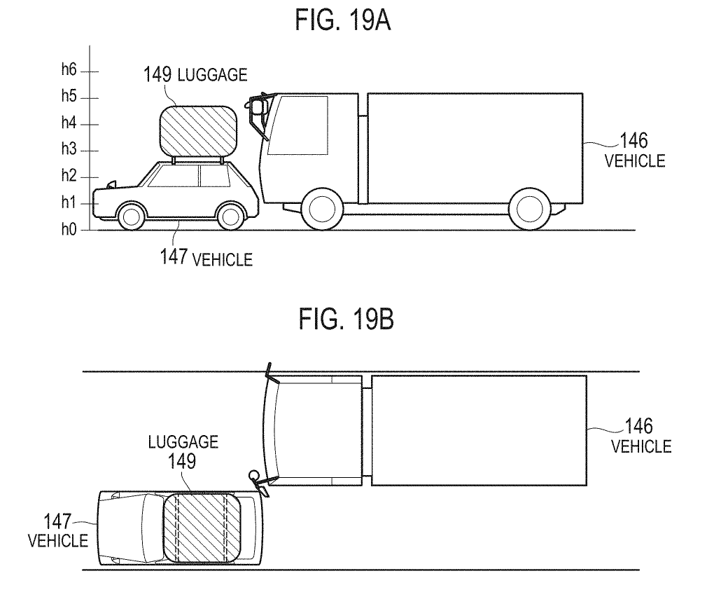

FIGS. 17A to 17B and FIGS. 18A to 18B illustrate an example of a camera for height scanning FIGS. 19A to 19B are diagrams illustrating road use according to the present embodiment.

As illustrated in FIGS. 17A to 17B, a sensor 151 is disposed at a front portion of the vehicle 150, a sensor 152 is disposed at a side surface thereof, and a sensor 153 is disposed at a rear portion thereof. The occupied area at each height is inspected from the bottom to the top by using each sensor. As the sensor, for example, an image sensor such as a camera is used, and the occupied area is detected based on a focusing distance in each direction. In addition, the occupied area is detected based on a distance measurement result in each direction by using an infrared transmission/reception unit. Such measurement is performed, for example, before transmitting the travel request to the route assignment server 200. It is possible to increase measurement accuracy by arranging a large number of sensors. In addition, in a case where there is a possibility that a projecting object projecting outward from a vehicle compartment by opening a window, a sunroof, or the like is present, the sensor may be arranged so that such a projecting object can be measured.

As illustrated in FIGS. 18A to 18B, the vehicle 150 carries a plate-shaped luggage 154 thereon. The sensor 151 measures the protruding degree of the luggage 154 protruding above the windshield. The sensor 152 detects that the luggage 154 does not protrude to the side of the vehicle. The sensor 153 measures the protruding degree of the luggage 154 protruding upward from the rear glass. As a result, by placing the luggage 154, the occupied area at the height h3 to h4 of the vehicle 150 is increased only from the roof portion of the vehicle 150 by the amount of the luggage 154 placed thereon and further projects forward and backward.

As illustrated in FIGS. 19A to 19B, the road is a one-way road, and the width of the road is the same as in FIGS. 15A to 15B and FIGS. 16A to 16B. The vehicle 147 carries a luggage 149 above the vehicle. The vehicle height of the vehicle 147 is lower than a height h3. Therefore, as illustrated in FIGS. 16A to 16B, the vehicle 146 and the vehicle 147 were able to travel in parallel. However, as illustrated in FIGS. 19A to 19B, as a result of inspecting the occupied area for each height by using the sensor, it is detected that the height added with the luggage 149 exceeds a height h4. As a result, it can be seen that the vehicle 146 and the vehicle 147 cannot travel in parallel. As a result, the route assignment server 200 instructs the vehicle 146 and the vehicle 147 not to travel in parallel.

(Scan by Balance Change)

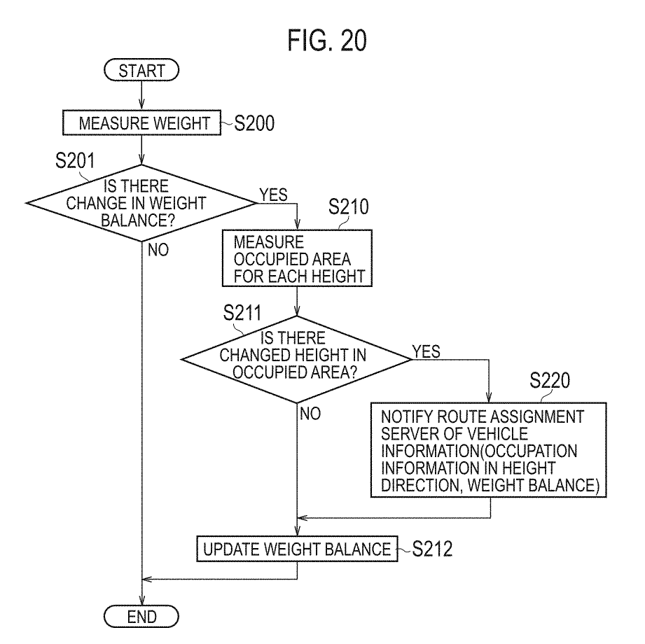

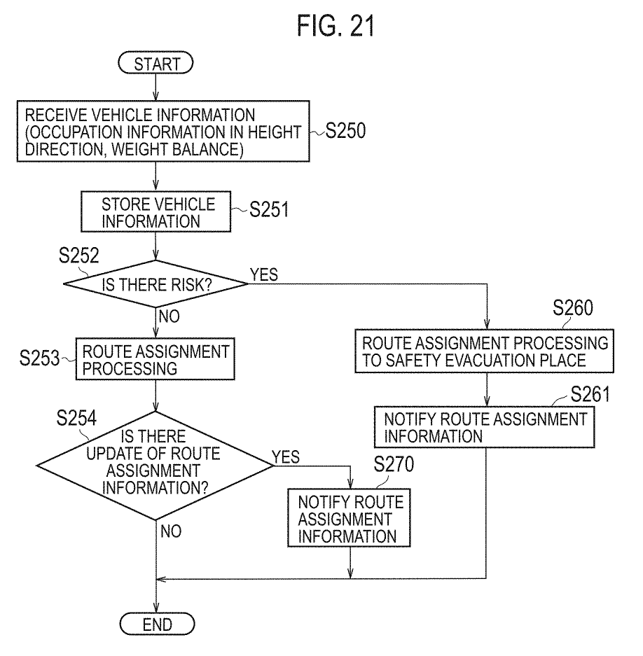

FIG. 20 is a processing flowchart of the vehicle 100 of height scanning by a balance change. FIG. 21 is a processing flowchart of the route assignment server of height scanning by a balance change.

As illustrated in FIG. 20, in the vehicle 100, a weighing scale which is a sensor is disposed near each tire to measure the weight of each tire (step S200). The vehicle 100 compares the measured weight balance with the weight balance previously measured and stored (step S201). As a result of the comparison, if there is a difference (step S201: YES), the vehicle 100 measures the occupied area for each height (step S210). As a result of the measurement, if there is a change in the occupied area (step S211: YES), the vehicle 100 notifies the route assignment server 200 of vehicle information (measurement information) such as information on the occupied area in the height direction and weight balance (step S220). The vehicle 100 updates the weight balance (step S212). If there is no change in the occupied area (step S211: NO), the vehicle 100 updates the weight balance (step S212). If there is no difference in weight balance (step S201: NO), the process is ended as it is.

FIG. 21 is a flowchart when the route assignment server 200 receives the vehicle information from the vehicle 100. The route assignment server 200 receives the vehicle information (step S250). The route assignment server 200 stores the vehicle information in association with the vehicle 100 (step S251). If the route assignment server 200 determines that there is a risk based on the vehicle information (step S252: YES), the route assignment server 200 performs route assignment processing so as to move the vehicle 100 to a safety evacuation place (step S260). The route assignment server 200 notifies the vehicle 100 of the route assignment information (step S261). If the route assignment server 200 determines that there is no risk (step S252: NO), the route assignment server 200 redoes the route assignment processing (step S253). If there is a difference from the route assignment information previously notified, the route assignment server 200 determines that it is necessary to update the route assignment information (step S254: YES). The route assignment server 200 notifies the vehicle 100 of the route assignment information to be updated (step S270). If the route assignment processing is performed, the route assignment server 200 performs the route assignment in consideration of the occupied area indicated by the received vehicle information and the weight balance.

The risk means, for example, a case where it is highly likely that a luggage collapse will occur. If the occupied area continues to change with the lapse of time, the route assignment server 200 determines that there is a risk. The route assignment server 200 forcibly moves to a safety evacuation place when the route assignment server 200 determines that there is a risk, thereby avoiding the occurrence of accidents due to the falling of luggage or the like.

(Scan by Window Opening)

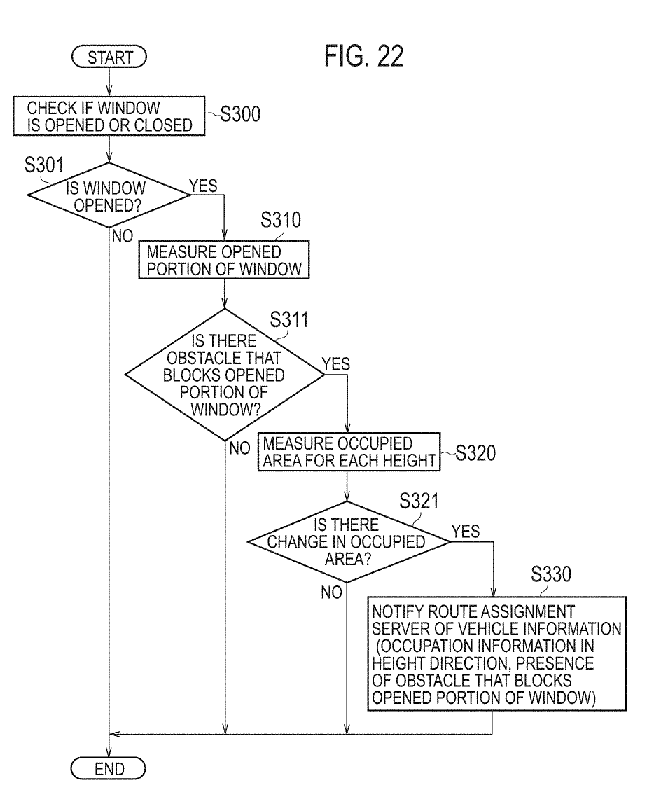

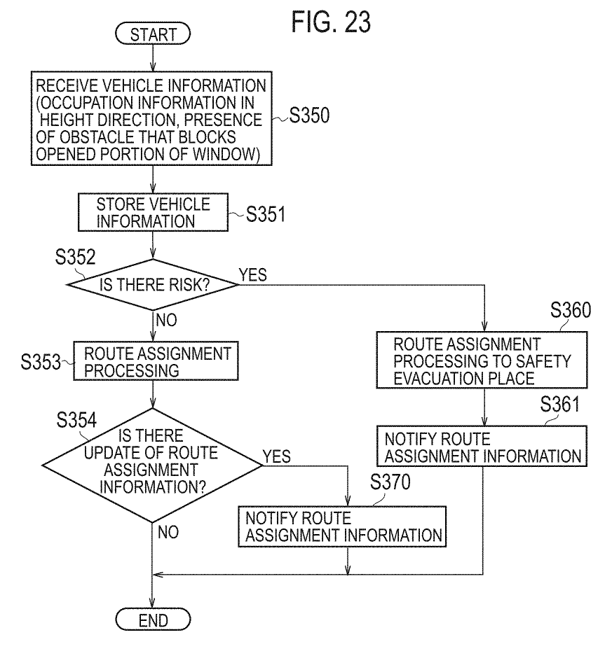

FIG. 22 is a processing flowchart of the vehicle 100 of height scanning by window opening. FIG. 23 is a processing flowchart of the route assignment server 200 of height scanning by window opening.

As illustrated in FIG. 22, the vehicle 100 confirms an opening/closing state of a window (step S300). If the vehicle 100 determines that the window is opened (step S301: YES), the vehicle 100 measures whether there is an obstacle that blocks the opened portion of the window (step S310). As a result of the measurement, if the vehicle 100 determines that there is an obstacle (step S311: YES), the vehicle 100 measures an occupied area (step S320). If the vehicle 100 determines that there is a change in the occupied area (step S321: YES), the route assignment server 200 is notified of vehicle information (measurement information) including information about the occupied area in the height direction and information indicating that there is the obstacle that blocks the opened portion of the window (step S330).

FIG. 23 is a flowchart when the route assignment server 200 receives vehicle information from the vehicle 100. The route assignment server 200 receives vehicle information (step S350). The route assignment server 200 stores the vehicle information in association with the vehicle 100 (step S351). If the route assignment server 200 determines that there is a risk from the vehicle information (step S352: YES), the route assignment server 200 performs route assignment processing so as to move the vehicle 100 to a safety evacuation place (step S360). The route assignment server 200 notifies the vehicle 100 of the route assignment information (step S361). If the route assignment server 200 determines that there is no risk (S352: NO), the route assignment server 200 redoes the route assignment processing (step S353). If there is a difference from the route assignment information previously notified, the route assignment server 200 determines that it is necessary to update the route assignment information (step S353: YES). The route assignment server 200 notifies the vehicle 100 of the route assignment information to be updated (step S370).

When the route assignment processing is performed, the route assignment is performed in consideration of the occupied area indicated by the received vehicle information. The risk means, for example, that a possibility that a child is putting his/her head or hand out of a window or a sunroof is high, and the child continues to keep putting his/her head or hand out of the window or the sunroof even when the vehicle itself warns the risk. If the situation is not improved with the lapse of time, the route assignment server 200 determines that there is a risk. When the route assignment server 200 determines that there is the risk, the route assignment server 200 forcibly moves the vehicle 100 to the safety evacuation place in consideration of the risk of unexpected protrusion, thereby avoiding the occurrence of the accident beforehand.

(Route Assignment Processing Considering Vibration)

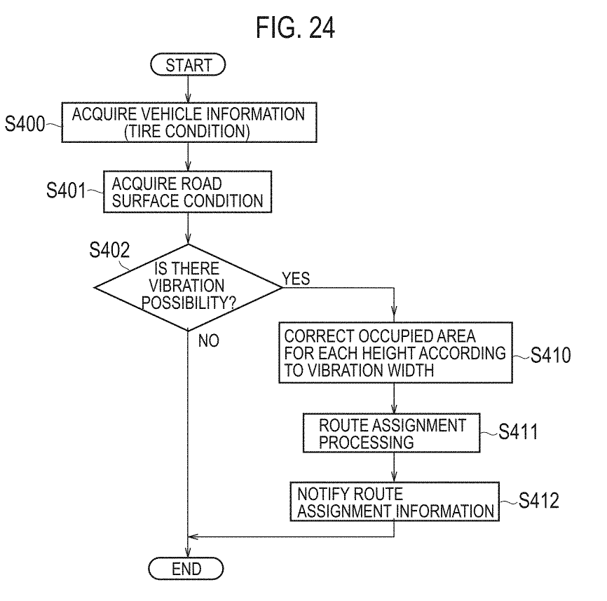

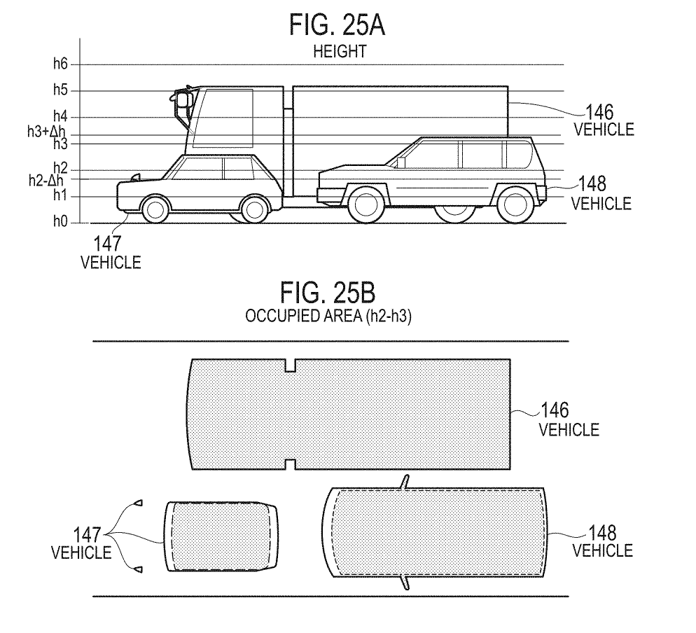

FIG. 24 is a flowchart of the route assignment server 200 by vibration possibility. FIG. 25 is a diagram illustrating an example of height occupied area processing when there is vibration possibility.

As illustrated in FIG. 24, when the route assignment processing of the vehicle 100 is performed, the route assignment server 200 acquires the situation of the vehicle, such as a tire, held as the vehicle information of the vehicle 100 (step S400). The route assignment server 200 acquires the road condition which is the route of the vehicle 100 (step S401). The route assignment server 200 determines whether there is a possibility of vibrating from the vehicle condition, the road condition, the assumed speed, and the like. If the route assignment server 200 determines that there is a vibration possibility (step S402: YES), the route assignment server 200 corrects the occupied area for each height from the assumed vibration width (step S410). The route assignment server 200 performs route assignment processing based on the corrected occupied area (step S411). The route assignment server 200 notifies the vehicle 100 of the route assignment information (step S412).

As illustrated in FIGS. 25A to 25B, FIG. 25A is a side view and (b) is a top view. The vibration width is ±Δh. The occupied area at the height h2 to h3 is used as the occupied area obtained by correcting the occupied area at h2−Δh to h3+Δh from the occupied area at h2 to h3 in FIG. 25A by taking into account the vibration component. In FIG. 25B, the shaded area is the original occupied area. In addition, all parts surrounded by lines are occupied areas after correction. It can be seen that the occupied area changes when considering the vibration component. Since the change of the occupied area in the vibration changes depending on the condition of the vehicle, the vibration amount is different even in the same place of the road. The condition of the road is measured by a measuring equipment of a road side strip or measured and collected by a preceding vehicle, and is the material of the road surface or the degree of unevenness. In addition, the tire condition is the tire model number, travel history, and the like.

(Example of Setting of Minute Interval)

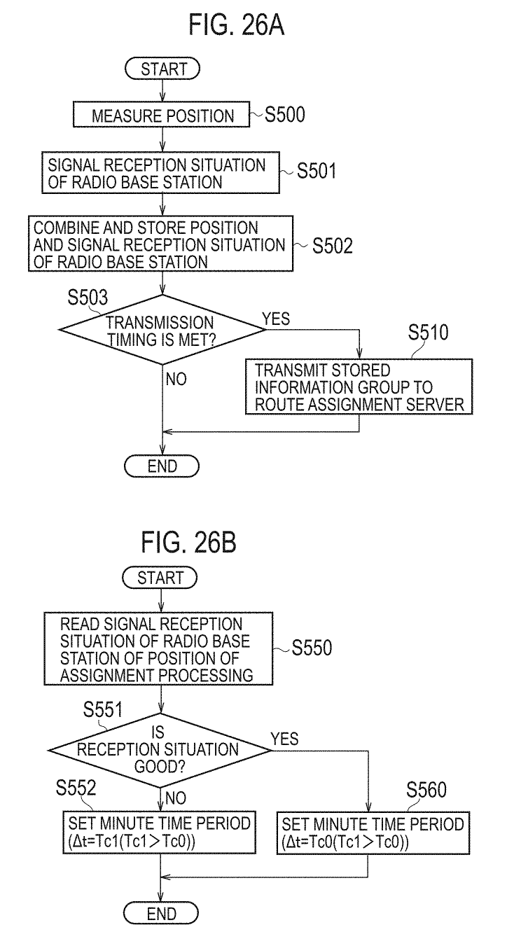

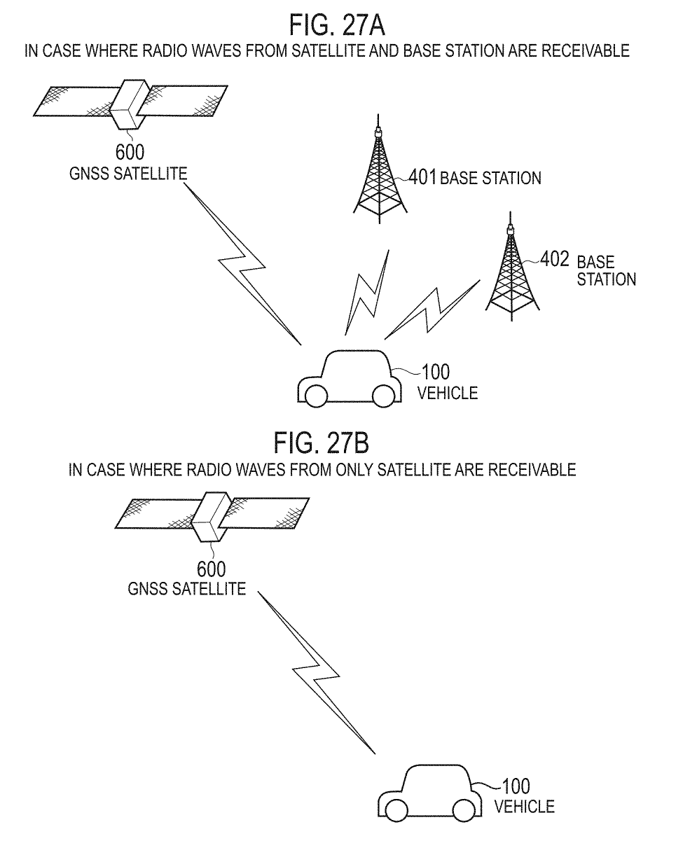

FIGS. 26A to 26B are flowcharts describing setting of a minute interval. FIG. 26A is a flowchart of the vehicle 100. FIG. 26B is a flowchart of the route assignment server 200. FIGS. 27A to 27B are diagrams illustrating reception of a synchronization reference signal. FIG. 27A illustrates a case where radio waves of a GNSS satellite 600 and a base station 400 (base stations 401 and 402 in FIG. 27A) are receivable, and FIG. 27B illustrates a case where only a radio wave of the GNSS satellite 600 is receivable.

As illustrated in FIG. 26A, the vehicle 100 measures the position by the GNSS (step S500). The vehicle 100 acquires a reception situation of a broadcast signal of the base station 400 (step S501). The vehicle 100 combines and stores the position and the reception situation of the broadcast signal of the base station 400 (step S502). If a transmission timing arrives (step S503: YES), the vehicle 100 transmits, to the route assignment server 200, information group obtained by combining the stored position and the stored reception situation of the broadcast signal of the base station 400 (step S510). The route assignment server 200 stores the received information group sent from the vehicle in the road condition storage unit 204.

As illustrated in FIG. 26B, when the route assignment server 200 performs the route assignment processing of the vehicle, the route assignment server 200 reads, from the road condition storage unit 204, the reception situation of the broadcast signal of the base station 400 corresponding to the position to be assigned (step S550). If the reception situation is good, for example, if the reception strength is equal to or higher than a predetermined value (step S551: YES), the route assignment server 200 sets a minute value as the minute period Δt (Δt=T_{c0} (T_{c0}<T_{c1}) (for example, T_{c0} is 1 ms)) (step S560). If the reception situation is not good (step S551: NO), the route assignment server 200 sets a large value as the minute period Δt (Δt=T_{c1} (T_{c0}<T_{c1}) (for example, T_{c1} is 1 sec)) (step S552). Each vehicle occupies the road area designated by each route assignment information at each time timing based on the same synchronization timing. If each vehicle can be synchronized with high accuracy, the route assignment server 200 shortens the minute period and performs control with high accuracy. On the other hand, if the synchronization accuracy of each vehicle is not very high, the route assignment server 200 performs control in a minute period of accuracy according to the accuracy accordingly. This provides safe driving.

As illustrated in FIG. 27A, the vehicle 100 receives radio waves from the GNSS satellite 600 and radio waves from the base station 401 and the base station 402. By receiving the radio waves from the GNSS satellite 600, the position of the vehicle 100 is grasped, the broadcast signals of the base station 401 and the base station 402 are received, and the position and the reception situation of each of the GNSS satellite, the base station 401, and the base station 402 are notified to the route assignment server 200. At the position, the route assignment server 200 selects a signal source (synchronization source) having a good reception situation and the highest synchronization accuracy by using, as a reference signal, a signal capable of acquiring the highest synchronization accuracy among the GNSS satellite 600, the base station 401, and the base station 402 which the vehicle 100 can receive, and sets the synchronization based on the selected signal source. Similarly, the route assignment server 200 sets a minute period Δt. For example, at a certain position, if the reception situation of each of the GNSS satellite 600, the base station 401, and the base station 402 is good and the synchronization accuracy based on the communication scheme in the base station 402 is higher than the synchronization accuracy based on the communication scheme in the GNSS satellite 600 and the base station 401, the route assignment server 200 selects synchronization accuracy based on the communication scheme in the base station 402 and sets a minute period based on the synchronization accuracy.

As illustrated in FIG. 27B, the vehicle 100 receives only radio waves from the GNSS satellite 600. The position of the vehicle 100 is grasped by receiving radio waves from the GNSS satellite 600. When the vehicle 100 can be connected to communicate with the route assignment server 200, the vehicle 100 notifies the route assignment server 200 of the position and the reception situation of the GNSS satellite. If the reception situation of the GNSS satellite is good with respect to the position, the route assignment server 200 sets the synchronization accuracy based on the radio wave reception of the GNSS satellite and the minute period Δt.

If the synchronization accuracy based on the notification information from the vehicle 100 repeatedly gets better or worse in a shorter period, the route assignment server 200 performs a setting so that the repeated change does not occur. For example, a period in which the repeated change occurs is set so as to match a period with poor accuracy in that period. In addition, the route assignment server 200 broadcasts a correction value for matching one synchronization timing, to the vehicle 100, based on each position and the signal source. Therefore, even if each vehicle 100 individually travels in the occupied area for each minute period assigned by the route assignment server 200, the route assignment server 200 sets the occupied area based on the minute period and the synchronization accuracy corresponding to the position of each vehicle. Each vehicle 100 generates a timing to be synchronized, based on the indicated signal source and the correction value, and travels on the indicated occupation area in synchronization with this. Therefore, the vehicle 100 can travel without contacting the nearby vehicle 100. The GNSS satellite has been described as an example of the signal source (synchronization source), but may be a ground station.

### MODIFICATION EXAMPLES

In the following, a difference from the above-described embodiment will be mainly described with reference to modification examples.

The environment surrounding the traffic is constantly changing. If a rain or snow falls, the road surface condition of the road will change and the braking performance of the vehicle will be affected. Landslides occur due to heavy rain and the like, and sometimes the road is blocked. There is also the danger of the vehicle falling over by strong winds. On the other hand, even when the vehicle is composed of new parts at the time of delivery, the abrasion, deterioration, or the like progresses according to the condition of use and the braking ability is affected as a result. A modification example is an example that makes it possible to effectively utilize the space of the road while considering the change of the environment surrounding the traffic. In addition, in the modification example, even when a network (communication network) is interrupted, the vehicle can continuously travel by automatic driving.

(System Configuration)

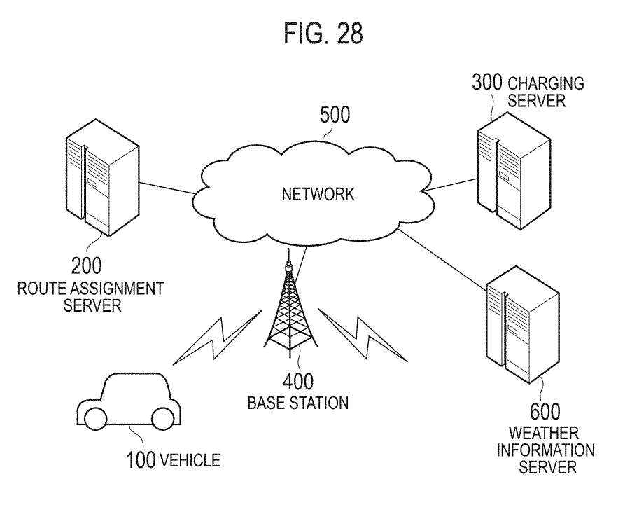

FIG. 28 is a diagram illustrating a configuration of a system according to a modification example.

As illustrated in FIG. 28, the system according to the modification example further includes a weather information server 600. The weather information server 600 communicates through a network 500. A route assignment server 200 acquires weather information from the weather information server 600. In addition, the route assignment server 200 acquires vehicle information from the vehicle 100 and environmental information measured by the vehicle 100. The route assignment server 200 calculates route assignment of each vehicle 100 by taking into account the weather information, the vehicle information, and the environmental information.

(Configuration of Vehicle)

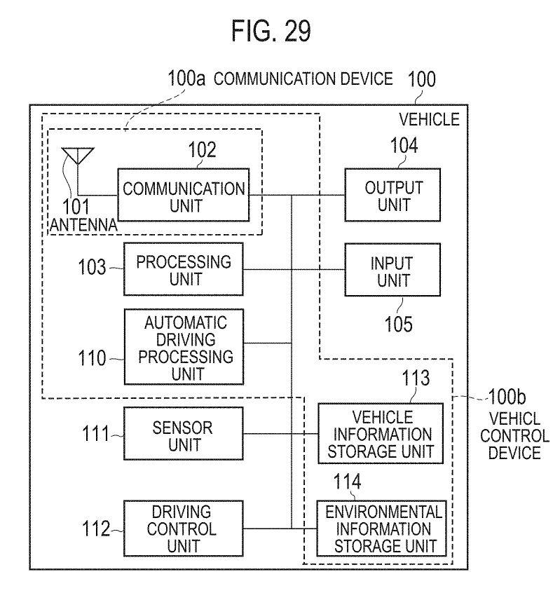

FIG. 29 is a diagram illustrating an example of the configuration of the vehicle 100 according to a modification example.

As illustrated in FIG. 29, the vehicle 100 further includes a vehicle information storage unit 113 and an environmental information storage unit 114. The vehicle information storage unit 113 stores the vehicle information including information about components constituting the vehicle, such as vehicle type, history of components, software version information, and the like. The environmental information storage unit 114 stores the environmental information measured by sensors.

The vehicle information storage unit 113 holds, for example, a model number of the vehicle, a replacement history of the components, an abrasion condition, a model number of the software of the automatic driving processing, a version, and the like as the information about the components constituting the vehicle. An automatic driving processing unit 110 transmits, to the route assignment server 200, the vehicle information held in the vehicle information storage unit 113 according to the instruction of the route assignment server 200.

The environmental information storage unit 114 stores environmental information around the vehicle, such as a temperature, a pressure, a humidity, a wind direction, a wind pressure, a rainfall, a snow cover, a road surface condition (irregularity information, flooding, snow cover, frozen state), an image, a video, together with a measurement time and a measurement position. The automatic driving processing unit 110 measures each environmental information at each timing according to the instruction of the route assignment server 200, and holds the environmental information in the environmental information storage unit 114. The automatic driving processing unit 110 transmits the environmental information stored in the environmental information storage unit 114 to the route assignment server 200 based on the instructed timing.

(Configuration of Route Assignment Server)

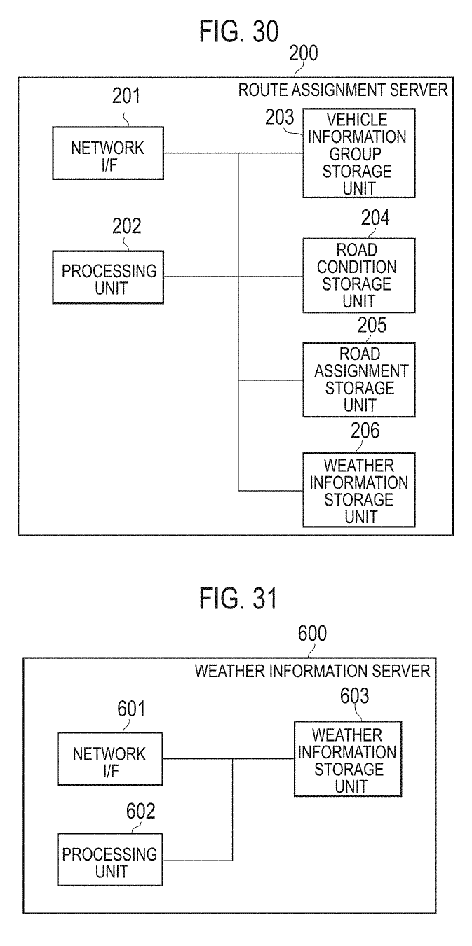

FIG. 30 is a diagram illustrating an example of the configuration of the route assignment server 200 according to a modification example.

As illustrated in FIG. 30, the route assignment server 200 further includes a weather information storage unit 206 that stores weather information. A processing unit 202 further performs communication with a weather information server 600. The processing unit 202 acquires weather information from the weather information server 600, acquires environmental information from the vehicle 100, and stores the weather information and the environmental information in the weather information storage unit 206. The processing unit 202 performs the assignment of the road based on the information held in the vehicle information group storage unit 203, the information held in the road condition storage unit 204, and the weather information and the environmental information held in the weather information storage unit 206. The processing unit 202 stores the road assignment result (road assignment) in the road assignment storage unit 205. The processing unit 202 notifies the vehicle 100 of the road assignment (route assignment) in the vehicle 100 through the network I/F 201.

(Configuration of Weather Information Server)

FIG. 31 is a diagram illustrating an example of the configuration of the weather information server 600 according to a modification example.

As illustrated in FIG. 31, the weather information server 600 includes a network I/F 601, a processing unit 602, and a weather information storage unit 603. The network I/F 601 is connected to communicate with the network 500. The weather information storage unit 603 stores weather information. The processing unit 602 receives a weather information request through the network I/F 601. The processing unit 602 returns the weather information held in the weather information storage unit 603 in response to the weather information request. Alternatively, if there is weather information to be transmitted, the processing unit 602 broadcasts the weather information.

(Example of Flow of Movement Setting)

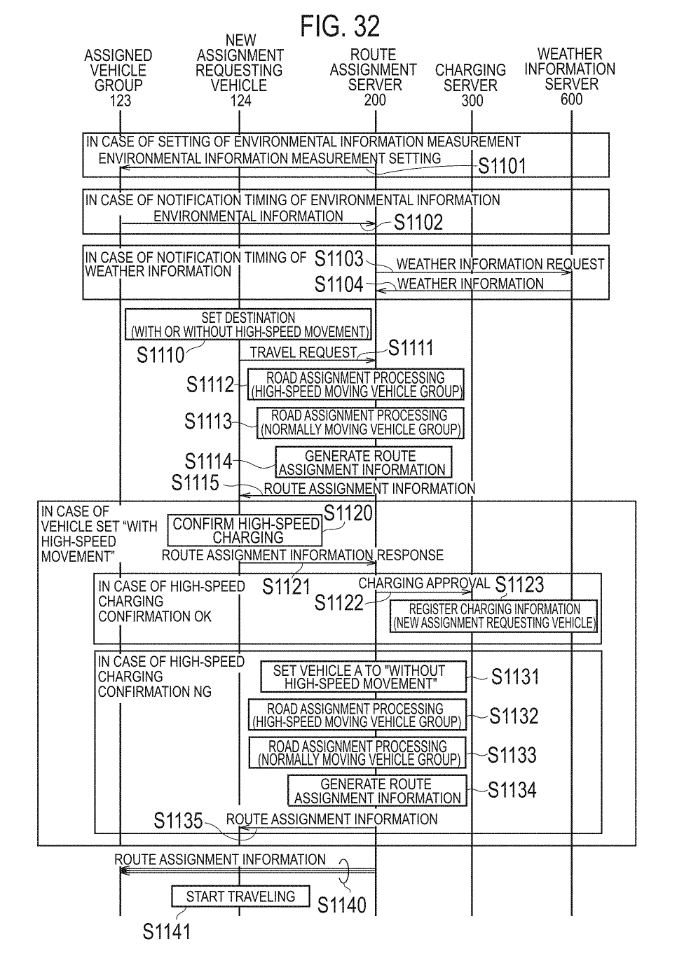

FIG. 32 illustrates an example of a flow of movement setting. The vehicles traveling on the road are classified into normally moving vehicles and high-speed moving vehicles. The normally moving vehicle is a vehicle that pays only the charging that is originally required to travel on the road. The high-speed moving vehicle is a vehicle that is allowed to travel faster than the normally moving vehicle by paying an additional charging in addition to the charging that is originally required for traveling on the road. The assigned vehicle group 123 is a group of vehicles that have already received the route assignment and includes the normally moving vehicles and the high-speed moving vehicles. A new assignment requesting vehicle 124 is a vehicle to which the route assignment is to be made.

As illustrated in FIG. 32, the route assignment server 200 transmits an environmental information measurement setting to the vehicle 100 determined to require a setting of environmental information measurement among the route-assigned vehicle group 123 (step S1101). The vehicle 100 having received the environmental information measurement setting starts measurement based on the environmental information measurement setting. If a broadcasting timing of the environmental information measured based on the environmental information measurement setting arrives, the vehicle 100 transmits the environmental information with the broadcasting timing to the route assignment server 200 (step S1102). The route assignment server 200 holds the received environmental information in the weather information storage unit 206.

If the route assignment server 200 determines that it is the timing when the weather information of the weather information server 600 is to be acquired, the route assignment server 200 transmits a weather information request to the weather information server 600 (step S1103). The route assignment server 200 receives the weather information as a response to the weather information request (step S1104), and holds the received weather information in the weather information storage unit 206.

In the new assignment requesting vehicle 124, the passenger operates the input unit 105 to set the destination and set “with high-speed movement” or “without high-speed movement” (step S1110). The new assignment requesting vehicle 124 notifies the route assignment server 200 of the set request as the travel request (step S1111). The travel request includes the vehicle information held in the vehicle information storage unit 113. The vehicle information includes information on components constituting the vehicle, such as a model number of the vehicle, a replacement history of the components, an abrasion situation, a model number of the software of the automatic driving processing, a version, and the like. The travel request includes measurement information. The measurement information is a weight, an occupied area for each height, and the like. The route assignment server 200 performs road assignment processing for the high-speed moving vehicle group based on the travel request, and the environmental information and the weather information stored in the weather information storage unit 206 (step S1112). Similarly, the route assignment server 200 performs the road assignment processing of the normally moving vehicle group (step S1113). The route assignment server 200 generates route assignment information of each vehicle (step S1114). The route assignment server 200 notifies the route assignment information to the new assignment requesting vehicle 124 (step S1115).

If the new assignment requesting vehicle 124 sets “with high-speed movement” in the travel request, the new assignment requesting vehicle 124 outputs the received route assignment information through the output unit 104 to urge the passenger to confirm the high-speed charging. The passenger inputs the high-speed charging confirmation OK/NG through the input unit 105 (step S1120). The new assignment requesting vehicle 124 transmits a route assignment information response including the high-speed charging confirmation to the route assignment server (step S1121).

If the high-speed charging confirmation of the route assignment information response is OK, the route assignment server 200 notifies a charging approval message to the charging server 300 (step S1122). The charging server 300 stores the charging information including the notified message in the charging information storage unit 303 (step S1123).

If the high-speed charging confirmation of the route assignment information response is NG, the route assignment server 200 sets the travel request of the new assignment requesting vehicle 124 to “without high-speed movement” (step S1131). The route assignment server 200 performs the road assignment processing of the high-speed moving vehicle group (step S1132). The route assignment server 200 performs the road assignment processing of the normally moving vehicle group (step S1133). The route assignment server 200 generates route assignment information of each vehicle (step S1134). The route assignment server 200 notifies the route assignment information to the new assignment requesting vehicle 124 (step S1135). The route assignment server 200 notifies the route assignment information to the assigned vehicle group 123 (step S1140). The new assignment requesting vehicle 124 starts traveling based on the received route assignment information (step S1141).

In the modification example, the route assignment server 200 performs the road assignment processing based on the vehicle information such as the model number of the vehicle in each vehicle, the replacement history of the components, the abrasion condition, the model number of the software of the automatic driving processing, the version, or the like, and the vehicle body condition measured by the vehicle. Therefore, it is possible to assign roads according to the traveling performance of individual vehicles, thereby avoiding contact accidents and enabling the high effective use of the road space. Furthermore, the route assignment server 200 performs road assignment processing by taking into account weather information and/or environmental information. This makes it possible to assign roads in consideration of deterioration of the accuracy of travel control accompanying deterioration of the traveling environment, thereby increasing the utilization efficiency of the road space without causing a contact accident.

(Flow of Information Acquisition)

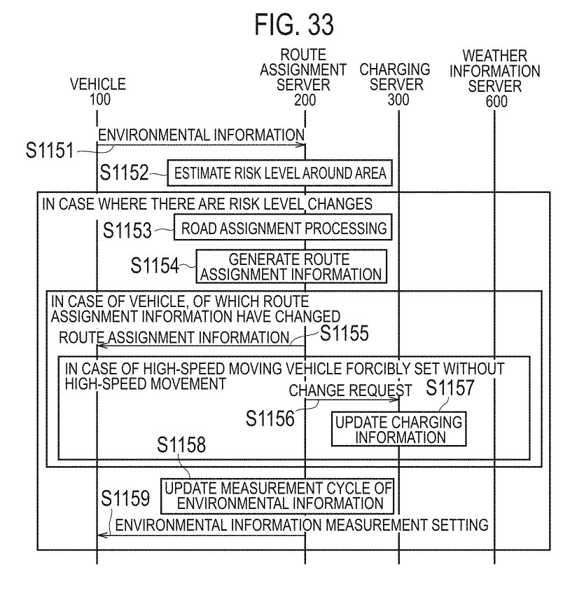

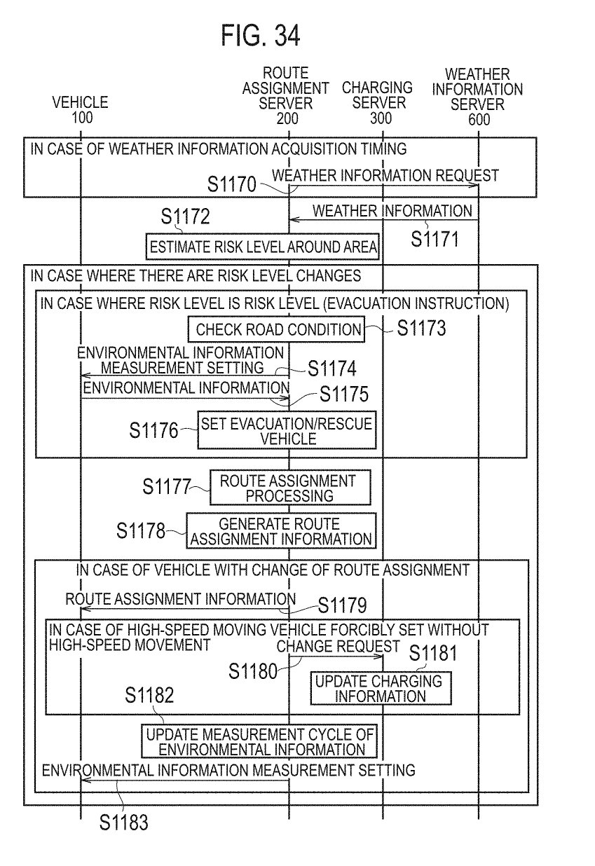

FIG. 33 illustrates an example of a flow at the time of acquiring environmental information. FIG. 34 illustrates an example of a flow at the time of acquiring weather information.

As illustrated in FIG. 33, the vehicle 100 included in the vehicle group transmits environmental information measured based on the request of the route assignment server to the route assignment server 200 (step S1151). The route assignment server 200 holds the received environmental information in the weather information storage unit 206. Based on the received environmental information and the weather information and the environmental information stored in the weather information storage unit 206, the route assignment server 200 estimates a risk level around the area indicated by the received environmental information (step S1152).

If the estimated risk level and the previously estimated risk level are compared and the risk level is determined as being changed, the route assignment server 200 performs road assignment processing (step S1153) and generates route assignment information of each vehicle (step S1154). As a result of generating the route assignment information, the route assignment server 200 transmits the route assignment information to the vehicle 100, of which the route assignment information has changed (step S1155).

If there is a high-speed moving vehicle that needs to be forcibly set without high-speed movement among the high-speed moving vehicles based on the estimated risk level, the route assignment server 200 transmits a charging change request to the charging server 300 with respect to charging for a high-speed moving vehicle forcibly set without high-speed movement (step S1156). The charging server 300 updates the charging information based on the change request (step S1157). The update contents are, for example, a charging termination, a temporary stop, or the like.

The route assignment server 200 determines the update setting of the measurement cycle of the environmental information based on the change of the risk level (step S1158) and transmits the environmental information measurement setting to the target vehicle 100 (step S1159). The vehicle 100 sets the environmental information to be measured, the measurement cycle, and the notification cycle based on the received environmental information measurement setting.

If the setting always requiring the measurement is performed, the route assignment server 200 may notify the vehicle 100 of the width of the predicted numerical value of the measurement value at each measurement timing. When the measurement value deviates from the expected numerical value range, the route assignment server 200 sets the vehicle 100 so as to notify the fact. Alternatively, when the measured value exceeds a value determined to change the degree of safety, the route assignment server 200 sets the measurement value in the vehicle 100 so as to notify the fact.

Regarding the transmission of the measurement value, the route assignment server 200 requests assignment of a transmission band (resource) to the base station 400 and/or the control server controlling the base station 400, based on the travel time of each vehicle at the position on the route assignment. Based on the response to the assignment request of the transmission band, the route assignment server 200 notifies each vehicle 100 of the position on the route assignment corresponding to the assigned transmission band and the communication means (radio communication parameter) in the base station 400. In this case, regardless of the individual vehicles 100, communication in one position (one area) is regarded as one terminal viewed from the base station 400. The vehicle 100 that needs to transmit at one position at the time of traveling performs communication using the communication means associated with that position. Thus, it is possible to acquire necessary information while reducing the load on the communication network.

As illustrated in FIG. 34, in the case of a weather information acquisition timing, the route assignment server 200 transmits a weather information request to the weather information server 600 (step S1170). If the weather information server 600 receives a weather information request or if weather information to be broadcast is generated, the weather information server 600 transmits weather information to the route assignment server 200 (step S1171). The route assignment server 200 holds the received weather information in the weather information storage unit 206.

Based on the received weather information and the weather information and the environmental information stored in the weather information storage unit 206, the route assignment server 200 estimates a risk level around the area indicated by the received environmental information (step S1172).

In a case where the estimated risk level is compared with the previously estimated risk level and the risk level around the area is determined as being changed, if the risk level is determined as a risk level (evacuation instruction), the route assignment server 200 performs a process of checking the road condition around the target area of the risk level (step S1173). For example, information collection from sensors provided on the road side strip and surveillance cameras, and information collection of the target road above which unmanned surveillance aircraft fly are performed.

The route assignment server 200 transmits an environmental information measurement setting to the vehicle 100 included in the vehicle group (step S1174), and acquires environmental information (step S1175). For example, captured images around the road are acquired. Based on these acquired information, the route assignment server 200 determines whether the road is unusable, such as presence or absence of falling objects on the road or collapse of the road. The route assignment server 200 sets evacuation/rescue vehicles for the vehicles existing around the target area (step S1176). If the evacuation/rescue vehicles are set, the route assignment server 200 estimates a change in the situation after the communication interruption, generates two or more pieces of route assignment information, sets a vehicle that transmits supplementary synchronization, and sets a communication means between vehicles of surrounding information and carries out and a vehicle that determines route information to be carried out.

The route assignment server 200 performs road assignment processing (step S1177), and generates route assignment information of each vehicle (step S1178). As a result of generating the route assignment information, the route assignment server 200 transmits the route assignment information to the vehicle 100, of which the route assignment information has changed (step S1179).

If there is a high-speed moving vehicle that needs to be forcibly set without high-speed movement among the high-speed moving vehicles based on the estimated risk level, the route assignment server 200 transmits a charging change request to the charging server 300 with respect to charging for a high-speed moving vehicle forcibly set without high-speed movement (step S1180). The charging server 300 updates the charging information based on the change request (step S1181). The update contents are, for example, a charging termination, a temporary stop, or the like.

The route assignment server 200 determines the update setting of the measurement cycle of the environmental information based on the change in the risk level (step S1182). The route assignment server 200 transmits the environmental information measurement setting to the target vehicle 100 (step S1183). The vehicle 100 sets the environmental information to be measured, the measurement cycle, and the notification cycle based on the received environmental information measurement setting.

### Specific Example

The route assignment server 200 sets the inter-vehicular distance to be longer than usual in the route assignment of the vehicle passing through the place where the environmental information is measured, based on the reception of environmental information that influences the accuracy of travel control, such as strong wind, snow cover, freezing, flooding, or the like from the vehicle. This makes it possible to suppress the risk of contact accidents between vehicles.

Similarly, the route assignment server 200 sets the inter-vehicular distance to be longer than usual in the route assignment of the vehicle passing through the place where the environmental information is measured, based on the reception of environmental information that influences the detection accuracy of travel positions, such as snow cover, freezing, flooding, or the like from the vehicle. This makes it possible to suppress the risk of contact accidents of objects.

The route assignment server 200 estimates the risk level of stopping the vehicle due to flooding with the amount of puddles of underpasses or mortar-shaped roads such as under eaves under heavy rain. The route assignment server 200 further estimates the risk level of landslide based on environmental information such as rainfall and weather information from the vehicle. Similarly, the route assignment server 200 estimates avalanche risk based on snow accumulation information based on weather information and environmental information such as sunshine and temperature rise. Similarly, the route assignment server 200 estimates the risk of tornado based on tornado warning information based on weather information and environmental information such as barometric pressure change. As a result of these estimations, the route assignment server 200 sets a traveling vehicle interval to be wide. This makes it possible to reduce the number of vehicles involved when landslides, avalanche, and tornadoes occur.

The route assignment server 200 prevents the occurrence of ruts by assigning routes so that the traveling positions of the vehicles do not concentrate at specific positions, and avoids the occurrence of vibrations when straddling ruts, based on environmental information obtained by measuring irregularities on the road surface.

The route assignment server 200 can detect a damaged portion of the road surface and makes it possible to repair the road surface at an early stage.

The route assignment server 200 estimates the size of the bound according to the traveling speed based on the vehicle information such as the level difference of the road surface based on the unevenness of the road surface and the weight and size of the vehicle including the load. The route assignment server 200 estimates the magnitude of the inclination according to the traveling speed, based on the vehicle information such as the curvature of the curve and the weight and size of the vehicle including the load. The route assignment server 200 assigns the road based on these estimation results, thereby making it possible to effectively utilize the road space without causing contact accidents.

If the route assignment server 200 determines that it is the risk level (evacuation instruction), the route assignment server 200 calculates the route for picking up and evacuating residents for all vehicles determined to be suitable for evacuation/rescue vehicles out of the vehicles in the area where evacuation instructions are issued, and travels on the calculated route. The route assignment server 200 moves vehicles not determined to be suitable for evacuation/relief vehicles without passengers to a place that does not become an obstacle to evacuation. This enables efficient and rapid evacuation. Here, vehicles suitable for evacuation/relief vehicles are, for example, vehicles already having passengers, vehicles with a large number of boarding persons, vehicles having fuel required for evacuation, and the like.

The route assignment server 200 estimates a change in the road condition after the blocking in preparation for a case where the radio communication network is interrupted, calculates two or more pieces of route information, and notifies the vehicle in advance. As a result, after the radio communication network is interrupted, evacuation can be continued without the vehicle stalling when the road condition deteriorates.

By propagating the deterioration of the road condition between the vehicles, it is possible to select a route to be selected as a detour route, and the entire vehicles are switched to traveling to the detour route selected at the same time. Therefore, prompt evacuation is possible without confusion.

By defining a vehicle that broadcast synchronization that is supplemented beforehand in response to the deterioration of the synchronization accuracy due to the communication interruption of the base station, it is possible to prevent extreme deterioration of the synchronization accuracy, thereby making it possible to run without significantly lowering the density of the vehicles on the road.

Even when the measurement of the traveling position is difficult due to the deterioration of the road surface condition and the change of the surrounding condition, the traveling position based on the positional relationship based on the reference vehicle is calculated by previously defining the reference vehicle. This makes it possible to travel without extremely reducing the positional accuracy.

(Updating Flow of Vehicle Information)

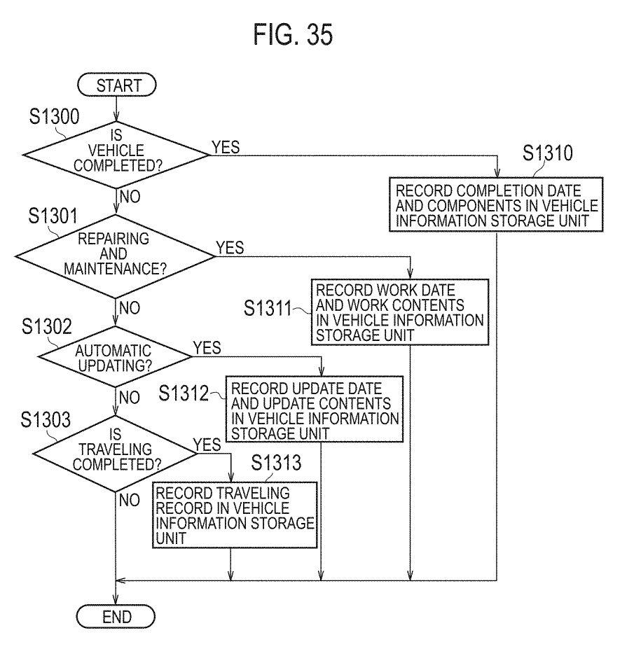

FIG. 35 illustrates an example of a flowchart of updating the vehicle information storage unit 113.

As illustrated in FIG. 35, if the vehicle is completed (step S1300: Yes), the vehicle 100 records a completion date, a type of the vehicle, and components (hardware, software) of the vehicle in the vehicle information storage unit 113 (step S1310). If repairing and maintenance are performed (step S1301: Yes), the vehicle 100 records work contents such as work date of repairing and maintenance or replaced or added components (hardware, software) in the vehicle information storage unit 113 (step S1311). If automatic updating of software or the like is performed (step S1302: Yes), the vehicle 100 records the update contents such as a update date, a version of the software that has updated, and the like in the vehicle information storage unit 113 (step S1312). Upon completion of the traveling (step S1303: Yes), the vehicle 100 records traveling records such as running time, traveling route, and the like in the vehicle information storage unit (step S1313).

(Flow of Travel Request)

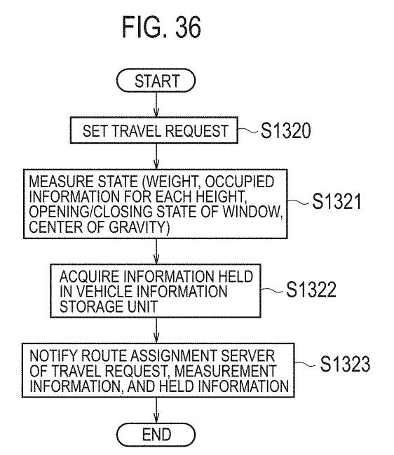

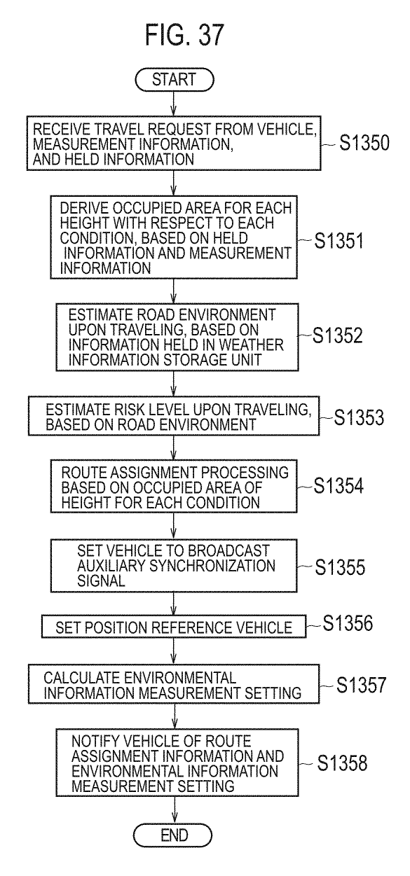

FIG. 36 illustrates an example of a flowchart of the vehicle at the time of travel request. FIG. 37 illustrates an example of a flowchart of the route assignment server at the time of travel request.

As illustrated in FIG. 36, in the vehicle 100, a passenger sets a travel request such as where he/she wants to go to and how to request high-speed movement (step S1320). The vehicle 100 measures the state of the vehicle such as the occupied area for each weight and height of the vehicle, the opening/closing state of the window, the center of gravity of the vehicle, and balance (step S1321). The vehicle 100 reads vehicle information from the vehicle information storage unit 113 (step S1322). The vehicle 100 notifies the route assignment server 200 of the travel request, the measurement information of the state of the vehicle, and the vehicle information held in the vehicle information storage unit 113 (step S1323).

As illustrated in FIG. 37, the route assignment server 200 receives the travel request from the vehicle, the measurement information of the state of the vehicle, and the vehicle information held in the vehicle information storage unit 113 (step S1350). The route assignment server 200 calculates an occupied area for each height of the vehicle with respect to each of various road conditions, based on the vehicle information and the measurement information (step S1351). The route assignment server 200 estimates a road environment after the present time based on the weather information and the environmental information held in the weather information storage unit 206 (step S1352). The route assignment server 200 estimates the risk level of the road based on the estimated road environment (step S1353). The route assignment server 200 performs route assignment processing based on the occupied area for each height of each vehicle, the estimated road environment, and the risk level for each of the various calculated road conditions (step S1354). When necessary, the route assignment server 200 selects a vehicle as a vehicle broadcasting an auxiliary synchronization signal, from among the traveling vehicles, and broadcasts the selected vehicle (step S1355). In addition, when necessary, the route assignment server 200 selects a vehicle as the position reference of the other vehicle from among the traveling vehicles, and broadcasts the selected vehicle (step S1356). The route assignment server 200 sets environmental information measurement (step S1357). The route assignment server 200 notifies the vehicle of the route assignment information and the environmental information measurement setting (step S1358).

(Processing Flow of Environmental Information and Weather Information)

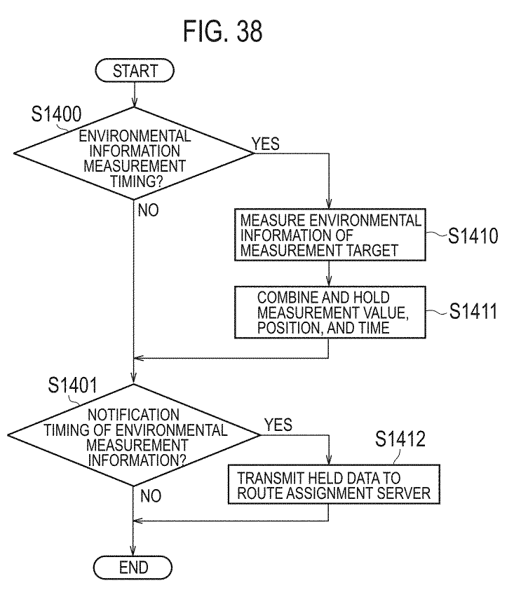

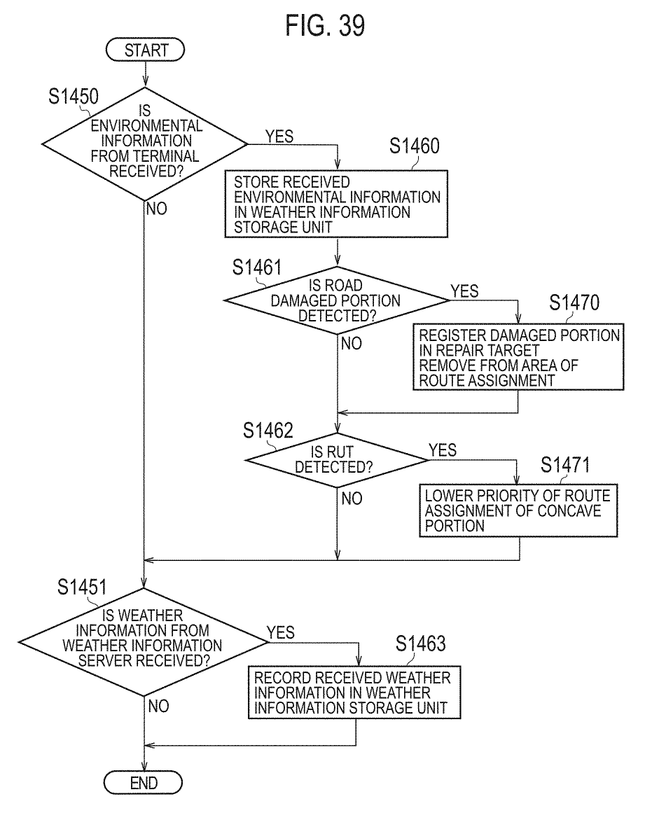

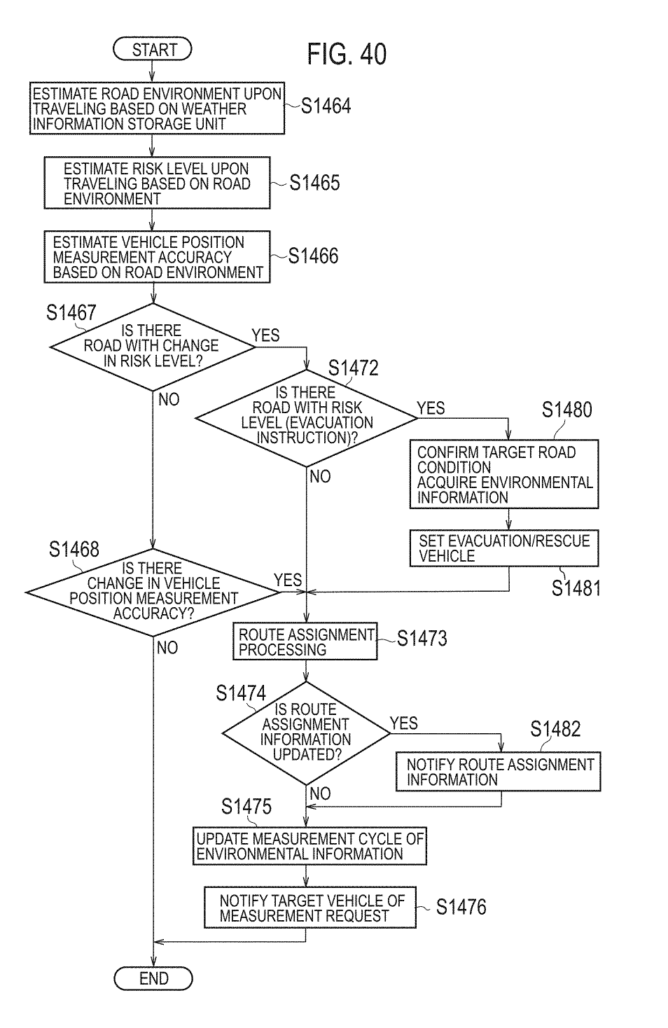

FIG. 38 illustrates an example of a processing flowchart of the vehicle at the time of measuring environmental information. FIG. 39 illustrates an example of a processing flowchart of the route assignment server at the time of receiving environmental information and weather information. FIG. 40 illustrates an example of a processing flowchart of the route assignment server at the time of updating the weather information storage unit.

As illustrated in FIG. 38, if a measurement timing arrives based on an environmental information measurement setting received from the route assignment server 200 (step S1400: Yes), the vehicle 100 measures environmental information of a measurement target (step S1410). The vehicle 100 combines and stores the measurement value, the position at the time of measurement, and the time at the time of measurement in the environmental information storage unit 114 (step S1411). The environmental information to be measured includes, for example, a wind direction, a wind pressure, an image of a road surface condition, an image of a surrounding situation, a temperature, a pressure, a humidity, a rainfall, a snowfall amount, and the like. If a notification timing based on the environmental information measurement setting arrives (step S1401: Yes), the vehicle 100 notifies the route assignment server 200 of the environmental information stored in the environmental information storage unit 114 (step S1412). If the vehicle 100 transmits the environmental information to the route assignment server 200, or if the notification of the environmental information to the route assignment server 200 succeeds, the vehicle 100 deletes the corresponding environmental information from the environmental information storage unit 114.

As illustrated in FIG. 39, if the route assignment server 200 receives the environmental information from the vehicle 100 (step S1450: Yes), the route assignment server 200 stores the received environmental information in the weather information storage unit 206 (step S1460). If the route assignment server 200 detects a road damaged portion from the received environmental information (step S1461: Yes), the route assignment server 200 registers the damaged portion as a repair target and removes the damaged portion from the road area of the route assignment (step S1470). In addition, if a rut is detected from the received environmental information (step S1462), the route assignment server 200 lowers the priority of route assignment of the road area having the concave portion (step S1471). The route assignment server 200 preferentially assigns convexities at the time of route assignment so as to reduce the difference in unevenness of the road so that the road surface is always flat. As a result, the influence on the traveling control due to the unevenness is prevented from occurring. If the weather information from the weather information server 600 is received (step S1451: Yes), the route assignment server 200 stores the received weather information in the weather information storage unit 206 (step S1463).

As illustrated in FIG. 40, if the weather information storage unit 206 is updated in response to reception of the environmental information or reception of the weather information, the route assignment server 200 estimates a road environment after the present time based on the weather information and the environmental information stored in the weather information storage unit 206 (step S1464). The route assignment server 200 estimates the risk level of the road based on the estimated road environment (step S1465). The route assignment server 200 estimates the vehicle position measurement accuracy based on the estimated road environment (step S1466). If there is a road with a change in the risk level (step S1467: Yes), and if there is a road with the risk level (evacuation instruction) (step S1472: Yes), the route assignment server 200 confirms the target road by the sensor arranged in the roadside strip, the monitoring camera, and the flying of the unmanned surveillance aircraft, and acquires the environmental information from the vehicle around the target road (step 1480). In addition, the route assignment server 200 sets evacuation/rescue vehicles with respect to vehicles around the target road (step S1481). When necessary, the route assignment server 200 selects a vehicle as a vehicle broadcasting an auxiliary synchronization signal, from among the traveling vehicles, and broadcasts the selected vehicle. In addition, when necessary, the route assignment server 200 selects a vehicle as the position reference of the other vehicle from among the traveling vehicles, and broadcasts the selected vehicle. The route assignment server 200 performs route assignment processing (step S1473). As a result of the route assignment processing, if there is a vehicle with updated route assignment information (step S1474: Yes), the route assignment server 200 notifies the route assignment information (step S1482). The route assignment server 200 updates the measurement cycle of the environmental information according to the situation (step S1475) and notifies the target vehicle of the environmental information measurement setting (step S1476). In addition, if there is a change in vehicle position measurement accuracy (step S1468: Yes), or if there is no road with a risk level (evacuation instruction) (step S1472: No), the route assignment server 200 performs route assignment processing (step S1473). As a result of the route assignment processing, if there is a vehicle with updated route assignment information (step S1474: Yes), the route assignment server 200 notifies the route assignment information (step S1482). The measurement cycle of the environmental information according to the situation is updated (step S1475) and the environmental information measurement setting is notified to the target vehicle (step S1476).

(Setting of Occupied Area Considering Wind Pressure)

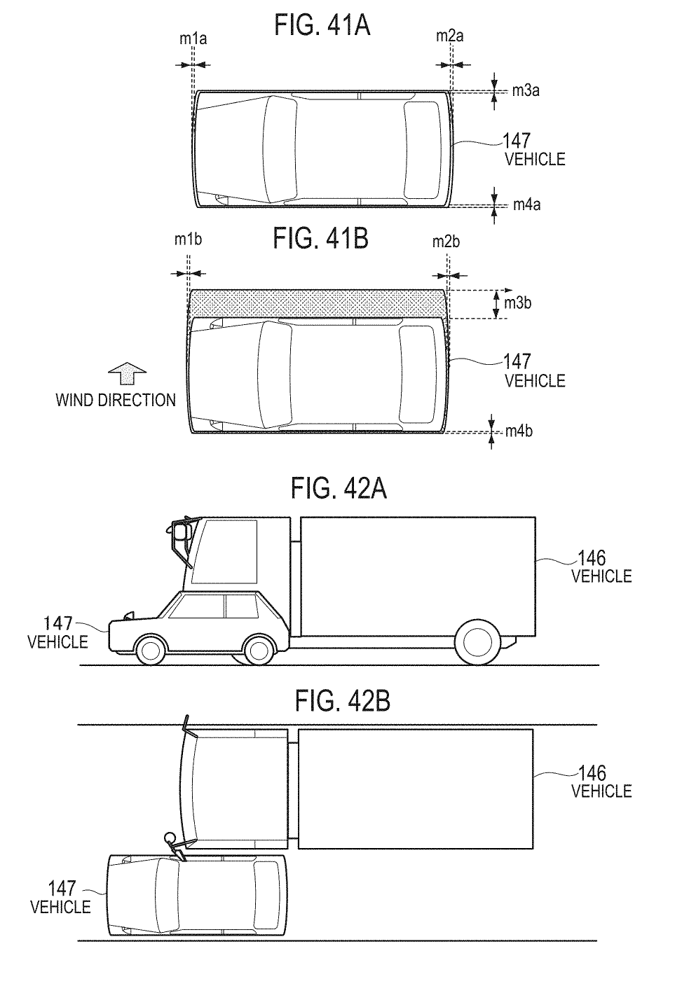

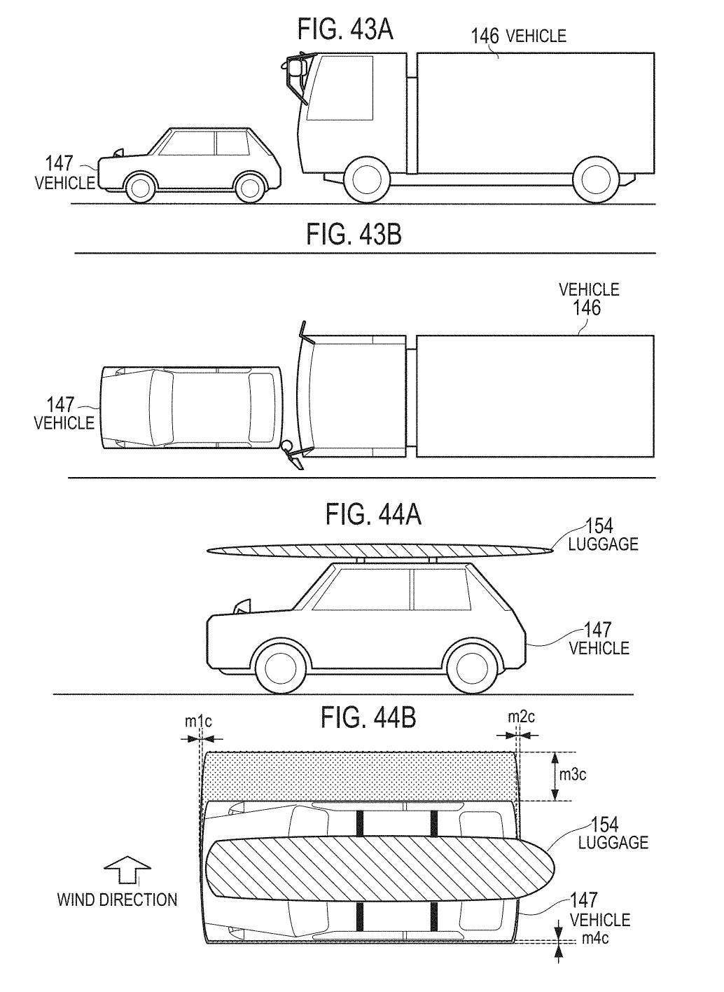

FIGS. 41A to 41B illustrate examples of setting of the occupied area by wind pressure. FIGS. 42A to 42B are diagrams illustrating road use in the case of no wind pressure. FIGS. 43A to 43B are diagrams illustrating road use in the case of wind pressure. FIGS. 44A to 44B illustrate examples of setting of the occupied area by wind pressure. The setting of the occupied area by the wind pressure in FIGS. 42A to 42B correspond to FIG. 41A. The setting of the occupied area by the wind pressure in FIGS. 43A to 43B correspond to FIG. 41B. In addition, the occupied area is indicated by shading (including the vehicle portion).

As illustrated in FIGS. 41A to 41B.) FIG. 41A illustrates a case where there is no wind pressure and FIG. 41B illustrates a case where there is the wind pressure. The wind pressure is applied from the left side of the vehicle 147. In the case where there is no wind pressure (FIG. 41A), the occupied area of the vehicle 147 is occupied in the occupied area based on the size of the vehicle 147, and the occupied area is larger by the accuracy of travel control based on vehicle information. The parts based on the accuracy of the travel control are the front m1a, the rear m2a, the right m3a, and the left m4a. On the other hand, in the case where there is the wind pressure (FIG. 41B), the parts based on the accuracy of the travel control are the front m1b, the rear m2b, the right m3b, and the left m4b, and the right m3b is large.

As illustrated in FIGS. 42A to 42B, FIG. 42A is a side view and FIG. 42B is a top view. In the case where there is no wind pressure, the vehicle 146 and the vehicle 147 are traveling in parallel. It seems from the top view of FIG. 42B that the side mirror of the vehicle 146 overlaps the upper side of the vehicle 147 and the upper side of the road side, but it can be seen from the side view of FIG. 42A that the side mirror of the vehicle 146 does not overlap the vehicle 147. The vehicle 146 and the vehicle 147 can travel in parallel with the vehicle. As a result, the route assignment server 200 instructs the traveling of the vehicle 146 and the vehicle 147 in parallel.

As illustrated in FIGS. 43A to 43B, FIG. 43A is a side view and FIG. 43B is a top view. In the case where there is the wind pressure, the vehicle 146 and the vehicle 147 are traveling in cascade. As illustrated in FIG. 41B, the occupied area is required for m3b on the right side by the wind pressure. Therefore, if trying to travel in parallel as illustrated in FIG. 42B, it can be seen that there is a risk that the vehicle 147 flows rightward due to the wind pressure and comes into contact with the vehicle 146. In addition, similarly to the vehicle 147, there is a possibility that the vehicle 146 will also be blurred to the right due to the wind pressure. Therefore, as illustrated in FIG. 42B, if traveling in the vicinity of the road side band on the right side of the road, there is a risk of flowing to the right side by the wind pressure and contacting the road side strip. As a result, as illustrated in FIG. 43B, the vehicles 146 and 147 assume the influence by the wind pressure and the route assignment server 200 instruct the traveling toward the left side.

As illustrated in FIGS. 44A to 44B, FIG. 44A is a side view and FIG. 44B is a top view. The vehicle 147 carries a plate-shaped luggage 154 above the vehicle. If the same wind pressure as in FIG. 41B is applied from the left side, the parts based on the accuracy of the travel control are the front m1c, the rear m2c, the right m3c, and the left m4c, and the right m3c is larger than the right m3b in FIG. 41B. In other words, it means that the risk of flowing to the right side is increased by the amount of loading of the plate-shaped luggage 154.

(Setting of Occupied Area by Taking into Account Aged Deterioration)

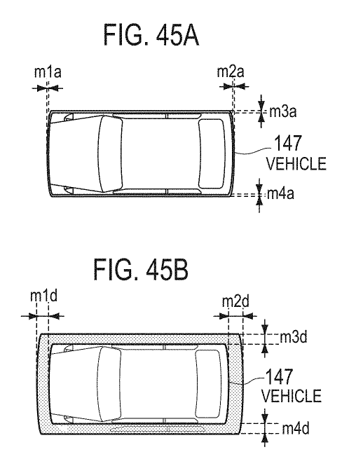

FIGS. 45A to 45B illustrate an example of setting of the occupied area by aged deterioration. FIG. 45A is a diagram illustrating the occupied area at the time of completion. FIG. 45B is a diagram illustrating the occupied area after lapse of time after completion. The occupied area is indicated by shading (including the vehicle portion).

As illustrated in FIGS. 45A to 45B, since there is no abrasion or aged deterioration of the parts as components immediately after completion, the area occupied by abrasion and deterioration does not increase (FIG. 45A). On the other hand, with the lapse of use time, various components are worn and deteriorated, and the degree of abrasion and deterioration increases. Thus, the occupied area required for not contacting the surroundings becomes wider (FIG. 45B).

(Setting of Occupied Area by Taking into Account Bound)

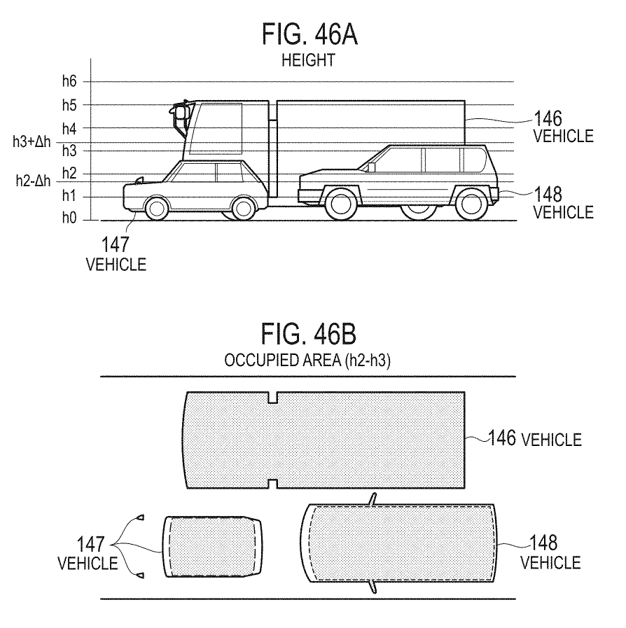

FIGS. 46A to 46B illustrate an example of setting of the occupied area by the bound. FIG. 46A is a side view and FIG. 46B is a top view.

As illustrated in FIGS. 46A to 46B, the route assignment server 200 detects a step or the like on the traveling road surface based on the environmental information, and determines that there is a possibility of bounding when the vehicle travels. In this case, the route assignment server 200 estimates the magnitude of the bound based on the vehicle information such as the weight of the traveling vehicle and the state of the tire (type of tire, degree of wear, state of suspension, or the like), the running speed, and the size of the step, and calculates the occupied area for each height according to the bound.

As illustrated in FIG. 46A, the magnitude of the bound is ±Δh. The occupied area at the height h2 to h3 is used as the occupation area where the occupied area at h2−Δh to h3+Δh is corrected in consideration of the ups and downs of the size to bound from the occupied area at h2 to h3. In FIG. 46B, the shaded area is the original occupied area, and the whole area surrounded by the line is the corrected occupied area. As a result of considering the magnitude of the ups and downs due to the bound, it can be seen that the occupied area changes. In the vehicle 147, if considering the occupied area of the height h3 to h4, since the height of the vehicle 147 is usually lower than h3, there is no occupied area. However, if the size of the bound is large, or if the difference between h3 and the normal height of the vehicle 147 is smaller than Δh, the vehicle 147 has the occupied area of the height h3 to h4 due to the bound. Since the change of the occupied area due to the ups and downs due to the bound also changes depending on the condition of the vehicle, the magnitude of the bound is different even in the same place of the road.

(Setting of Occupied Area by Taking into Account Road Surface Condition)

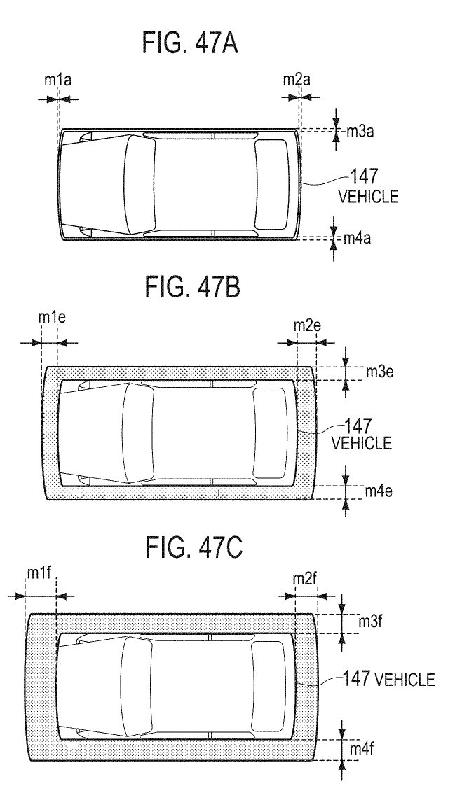

FIGS. 47A to 47C illustrate examples of setting of the occupied area according to the road surface condition. FIG. 47A is a diagram illustrating the occupied area in a case where the road surface is dry. FIG. 47B is a diagram illustrating the occupied area if the road surface is flooded. FIG. 47C is a diagram illustrating the occupied area in a case where the road surface is snowy. The occupied area is indicated by shading (including the vehicle portion).

As illustrated in FIGS. 47A to 47C, if the road surface is dry, there is no influence on the traveling control and the occupied area does not increase (FIG. 47A). On the other hand, if flooded, the traveling control will be affected by the resistance of the flooded water. Therefore, the occupied area becomes wider (FIG. 47B). In addition, if snow is piled up, the snow also affects the traveling control. Therefore, the occupied area becomes wider (FIG. 47C).

(Setting of Occupied Area in Curve)

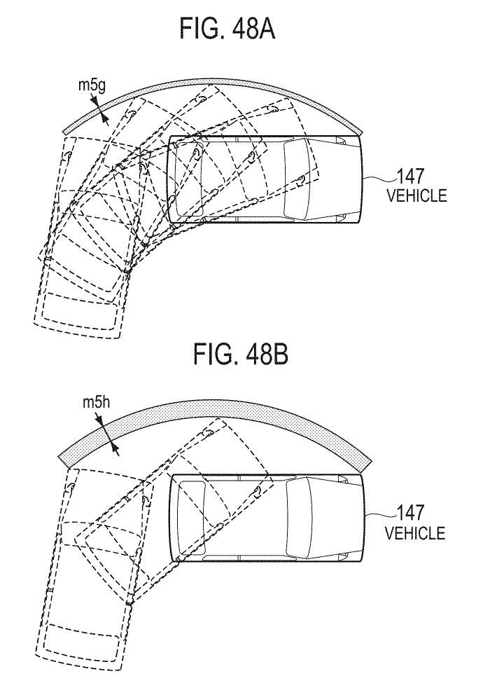

FIGS. 48A to 48B illustrate examples of setting of the occupied area in the curve. FIG. 48A illustrates a case where the curve is bent at a low speed. FIG. 48B illustrates a case where the curve is bent at a high speed. The traveling lines in FIGS. 48A and 48B are the same. The area occupied by the centrifugal force is indicated by shading (including the vehicle portion).

As illustrated in FIGS. 48A to 48B, if the curve is bent at a low speed, the centrifugal force is small (FIG. 48A). On the other hand, if the curve is bent at a high speed, the centrifugal force increases. Therefore, the occupied area is large (FIG. 48B).

(Auxiliary Position Information)

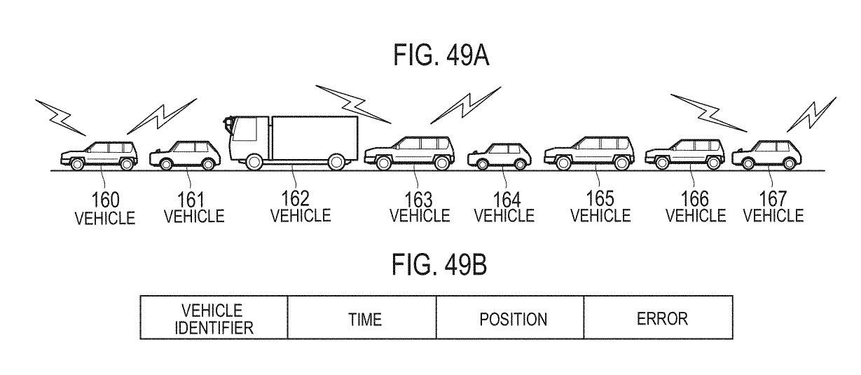

FIGS. 49A to 49B are diagrams illustrating broadcasting of auxiliary position information. FIG. 49A illustrates an example of assignment of reference vehicle. FIG. 49B illustrates an example of a signal broadcast by the reference vehicle.

As illustrated in FIGS. 49A to 49B, the route assignment server 200 requests transmission of auxiliary position information to a vehicle determined as having high position detection accuracy, based on vehicle information from the vehicle group according to the situation. The transmission request for the auxiliary position information includes a frequency band, a transmission timing, and a period for transmitting the auxiliary position information. The auxiliary position information to be transmitted includes an identifier of the vehicle to be transmitted, a time, a position corresponding to the time, and an error amount included in the position measurement of the vehicle (FIG. 49B).

The vehicle 160, the vehicle 163, and the vehicle 167 broadcast the auxiliary position information based on the designated transmission timing and/or cycle. The vehicle 161 located in the vicinity of the vehicle 160 can derive the position of the vehicle 161 from the position and measurement error of the vehicle 160 at the time of the received auxiliary position information of the vehicle 160 and the position of the vehicle 160 measured by the vehicle 161 at the same time, and can confirm whether the vehicle is traveling along the route assignment information assigned by the route assignment server 200 (FIG. 49A).

Regarding the vehicle 165, there are a vehicle 163 and a vehicle 167 for broadcasting auxiliary position information while skipping one. In this case, for example, the vehicle 165 treats the vehicle 164 traveling with reference to the vehicle 163 and/or the vehicle 166 traveling with reference to the vehicle 167 as proxy reference positions and calculates the vehicle position of the vehicle 165.

As a situation in which the route assignment server 200 requests transmission of auxiliary location information, for example, there is a case where it is determined that it is difficult to measure an accurate position by a certain type of position identification method, such as the change in roads and surrounding conditions due to snow accumulation or the like and grasping the position with visual position relationship.

(Auxiliary Synchronization Signal)

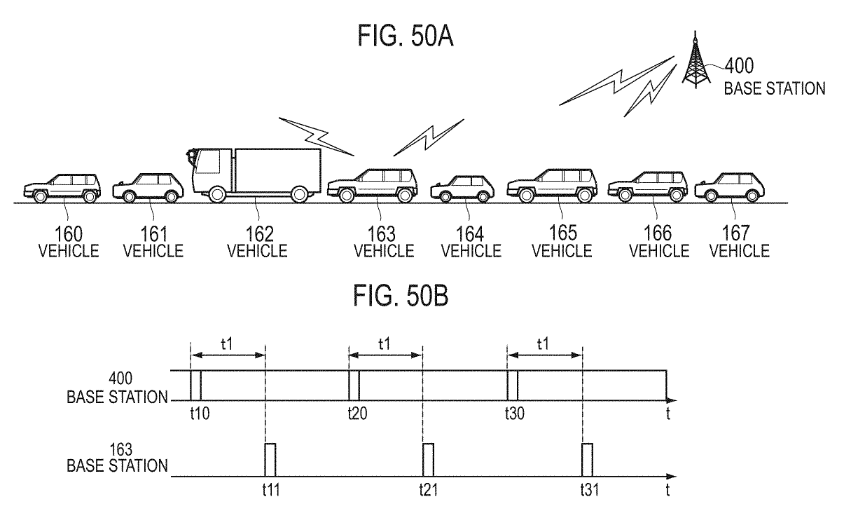

FIGS. 50A to 50B are diagrams illustrating the broadcasting of the auxiliary synchronization signal. FIG. 50A is a diagram illustrating an example of assignment of the broadcasting vehicle of the auxiliary synchronization signal. FIG. 50B is a diagram illustrating an example of the broadcasting timing of the auxiliary synchronization signal.

As illustrated in FIGS. 50A to 50B, the route assignment server 200 requests the transmission of the auxiliary synchronization to the vehicle determined as having high accuracy of an internal clock based on vehicle information from the vehicle group according to the situation (FIG. 50A). The auxiliary synchronization transmission request includes a frequency band for transmitting an auxiliary synchronization signal and a transmission timing of the auxiliary synchronization signal based on a synchronization timing from the base station (FIG. 50B). The vehicle 164 receives synchronization signals t10, t20, and t30 from a base station 400 and receives auxiliary synchronization signals t11, t21, and t31 broadcast from the vehicle 163. When the signal from the base station 400 ceases, the vehicle 164 measures the timing based on the auxiliary synchronization signal from the vehicle 163. This makes it possible to continue traveling based on the route assignment acquired from the route assignment server 200. Here, only one vehicle 163 broadcasts the auxiliary synchronization signal, but if a plurality of vehicles broadcast the auxiliary synchronization signals, the auxiliary synchronization signal to be broadcast from each vehicle is transmitted at different transmission timing.

The situation in which the route assignment server 200 requests the transmission of the auxiliary synchronization signal is, for example, a case where it is determined that there is a high possibility that the base station will be stopped due to natural disasters.

(Assignment of Radio Communication Scheme upon Interruption of Communication)

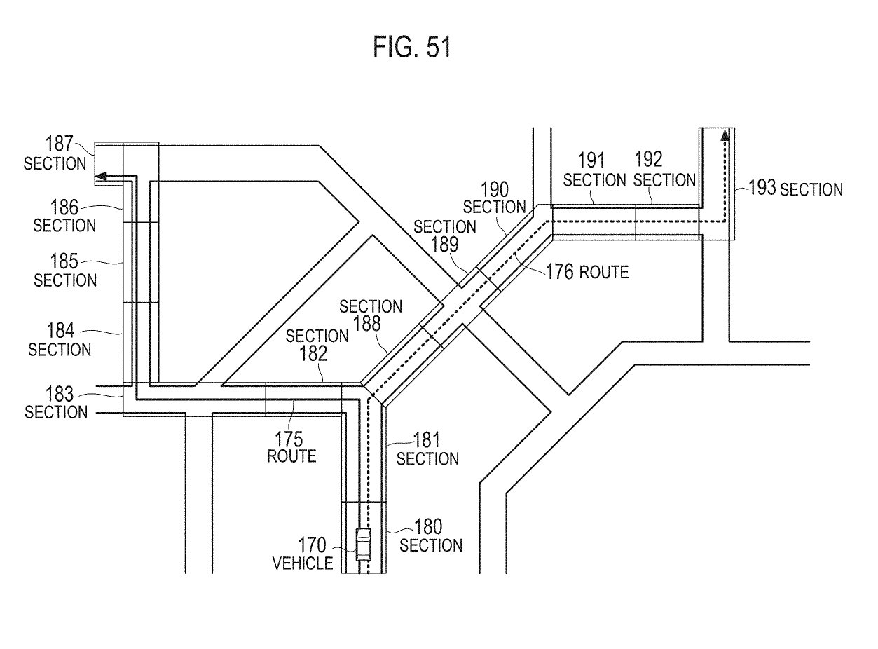

FIG. 51 is a diagram illustrating assignment of a radio communication scheme at the time of interrupting communication with the route assignment server. A route 175 and a route 176 are the route assignment of the vehicle 170 assigned by the route assignment server 200.

As illustrated in FIG. 51, the route assignment server 200 notifies the vehicle 170 of the two route assignments of the route 175 and the route 176. In addition, at the same time, the route assignment server 200 notifies the vehicle 170 of the route assignment and the communication means corresponding to the traveling position. In a situation in which the communication with the route assignment server 200 is interrupted, if information to be broadcast to the surrounding vehicles is generated, the vehicle 170 performs transmission by using the selected route and the communication means corresponding to the traveling position at the time of transmission. For example, if the vehicle 170 transmits the information in the section 184 while traveling on the route 175, the transmission is performed by using the communication scheme, the frequency band, the time period, and the transmission power set for the section 184 by the route assignment server 200. Similarly, if the vehicle 170 transmits the information in the section 190 while traveling on the route 176, the transmission is performed by using the communication scheme, the frequency band, the time period, and the transmission power set for the section 190 by the route assignment server 200.

When the route assignment server 200 assigns the communication scheme, the frequency band, the time period, and the transmission power, the route assignment server 200 sets the transmission of each vehicle so as not to interfere with each other, based on the route assignment of each vehicle. In addition, the transmission timing in each vehicle is performed based on the auxiliary synchronization signal. In other words, as a result of the route assignment, in a place where the density of the vehicles is low, the transmission power is increased and the information is set to reach the nearby vehicle. In a place where the density of the vehicles is dense, the transmission power is weakened and the information is set to reach only the nearby vehicle. Band assignment of each vehicle is performed so that simultaneous transmission and reception does not occur within the range that transmission is supposed to reach. Therefore, each vehicle can receive information transmitted from the nearby vehicle without interference. In addition, the transmission is possible without a concern about interference.

The route assignment server 200 sets a route number common to the entire vehicles to a route assigned to each vehicle. The entire vehicles use the route assignment of each vehicle assigned the same number. If a certain vehicle is traveling based on route assignment with route number 1, it is assumed that other vehicles are traveling based on the route assignment received from the route assignment server 200 as route number 1. If a certain vehicle moves to travel based on the route assignment of route number 2 for some reason, the other vehicles also move to travel based on the route assignment received from the route assignment server 200 as route number 2. For example, if a certain vehicle detects that the road on the traveling route is impassable while the certain vehicle travels according to a route, the route number is updated with a next route number. If the route of the next route number includes position information which has already been impassable, the route number is further updated with a next route number.

A vehicle that has detected that the road on the traveling route is impassible broadcasts the position information and the route number that are not allowed to pass, to nearby vehicle. The vehicle having received the broadcast holds the impassable position information and compares the current route number of the vehicle with the received route number. As a result of the comparison, if the route numbers are the same, the route numbers are used as they are. If the route numbers are different, it is checked whether the impassable position information is included in the route of the vehicle. If the impassable position information is not included, the route number of the vehicle is updated with the received route number, and the nearby vehicle is notified of the received impassable position information and the route number by broadcast. If the impassable position information is included, the route number of the vehicle is updated up to the route number not including the impassable position information, and the impassable position information and the updated route number are notified to the nearby vehicle by broadcast. Therefore, the entire vehicles are notified of the change of the route number, and the route can be switched without confusion.

(Assignment of Radio Communication Scheme When Communication is Enabled)

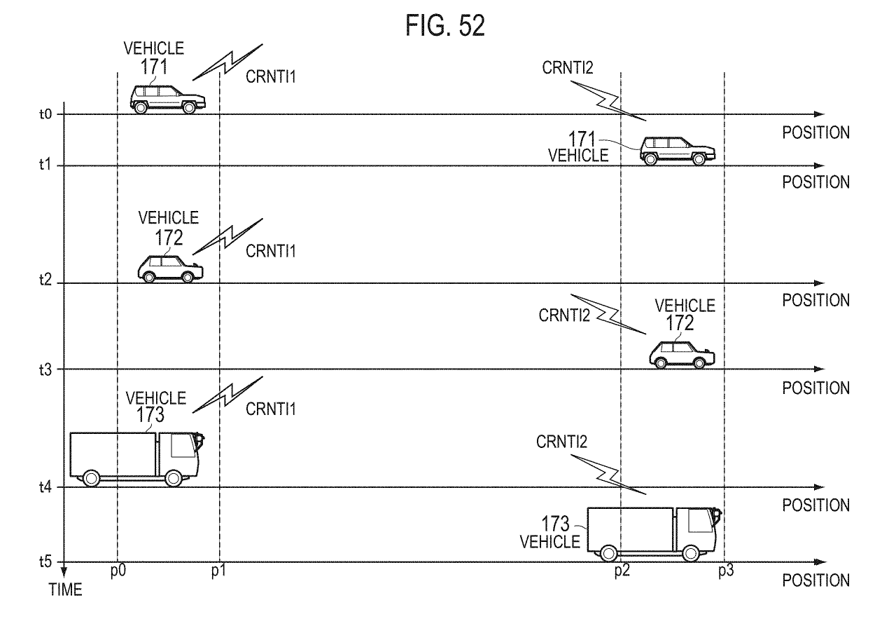

FIG. 52 is a diagram illustrating assignment of a radio communication scheme when communication with the route assignment server is possible.

As illustrated in FIG. 52, a vertical axis represents the time and a horizontal axis represents the position. A vehicle 171 travels position p0-p1 at time t0 and travels position p2-p3 at time t1. A vehicle 172 travels position p0-p1 at time t2 and travels position p2-p3 at time t3. A vehicle 173 travels position p0-p1 at time t4 and travels position p2-p3 at time t5.

The vehicle 171, the vehicle 172, and the vehicle 173 transmit the environmental information held in the environmental information storage unit 114 to the route assignment server 200 at the position p0-pl. At this time, in the radio communication with the base station 400, the vehicle 171, the vehicle 172, and the vehicle 173 use one entity as an entity to be used. For example, if the communication between the base station 400 and the vehicle 100 is LTE, the C-RNTI used at the position p0-p1 is common to all vehicles, for example, the vehicle 171, the vehicle 172, and the vehicle 173, and thus C-RNTI=CRNTI1.

Similarly, the vehicle 171, the vehicle 172, and the vehicle 173 receive the instruction from the route assignment server 200 at position p2-p3. At this time, in the radio communication with the base station 400, the vehicle 171, the vehicle 172, and the vehicle 173 use one entity as an entity to be used. For example, if the communication between the base station 400 and the vehicle 100 is LTE, the C-RNTI used at the position p0-p1 is common to all vehicles, for example, the vehicle 171, the vehicle 172, and the vehicle 173, and thus C-RNTI=CRNTI2.

In the vehicle 171, the vehicle 172, and the vehicle 173, the parameters required for radio communication at each of position p0-p1 and position p2-p3 are followed by the instructions from the route assignment server 200. The base station 400 assigns radio communication parameters based on the transmission timing and the data capacity requested by the route assignment server 200. Therefore, it is possible to perform communication without checking the transmission data capacity at the time of actual transmission.

[Supplementary Note 1]

A transportation system includes a vehicle that is connected to communicate with a network in radio communication and performs automatic driving, and a route assignment server that is connected to communicate with the vehicle through the network and calculates a traveling route of the vehicle. The route assignment server performs assignment of a road area occupied by the vehicle for each minute time period to a destination of the vehicle, based on a destination from the vehicle, vehicle information from the vehicle, and road information. The vehicle performs automatic driving based on the assignment of the road area.

The vehicle has a radio communication function, takes a timing based on synchronization in radio communication, and performs automatic driving.

The route assignment server receives the synchronization accuracy for each position from the vehicle and determines the length of the minute time period to assign the area occupied by the vehicle based on the accuracy of the synchronization.

The vehicle information has an occupied area indicating the area occupied by the vehicle for each height. The vehicle includes a sensor for inspecting the area occupied by the vehicle for each height.

The vehicle inspects the state of the vehicle at the time of traveling, and if a change in the situation of the vehicle is detected as a result of the inspection, the vehicle inspects the area occupied by the vehicle for each height by using the sensor and notifies this to the route assignment server.

When the notification that the situation of the vehicle, including the occupied area, has changed has been received from the traveling vehicle, if the presence of the risk with respect to the traveling is detected, the route assignment server guides the vehicle to a place where the vehicle can safely stop.

The route assignment server estimates the vibration degree of the vehicle body based on the vehicle information and the road conditions, corrects the occupied area based on the estimated vibration degree, and performs route assignment processing by using the corrected occupied area.

The vehicle has a priority, and the route assignment server generates route assignment information based on the priority of the vehicle.

The vehicle has a priority and performs charging based on the result of performing route assignment processing according to the priority.

[Supplementary Note 2]

A transportation system includes a vehicle that is connected to communicate with a network in radio communication and performs automatic driving, and a route assignment server that is connected to communicate with the vehicle through the network and calculates a traveling route of the vehicle. The route assignment server performs assignment of a road area occupied by the vehicle at each minute time of the vehicle, based on a travel request including a destination from the vehicle, a desired arrival time, or the like, measurement information obtained by measuring the state of the vehicle, vehicle information indicating the configuration of the vehicle, road information, weather information, and environmental information. The vehicle performs automatic driving based on the assignment of the road area.

The measurement information means information obtained by measuring the state of the vehicle, and includes an occupied area for each of weight, center of gravity, balance, height, an opening/closing state of a window, and the like.

The vehicle information means information about the state of components constituting the vehicle, and includes a model number of the vehicle, model numbers of the components of the vehicle, a use start date, a use time, a repair history, and the like.

The weather information includes warning/caution information about natural disasters such as weather forecast, weather warning/caution, typhoon, flood, sediment disaster, tornado, tsunami, earthquake, eruption, and the like.

The environmental information is information obtained when the vehicle measures the surroundings, and includes information about the state of the atmosphere (temperature, pressure, humidity, wind direction, wind pressure, rain, snow, hail, fog, and the like), the state of the road surface (unevenness, drying, flooding, snow covering, freezing, falling objects, breakage, and the like).

In one assigned position of the road area, a base station that performs radio communication with a terminal, or a base station control server that controls the base station requests bandwidth assignment of radio communication including the time for which one or more vehicles travel and the data capacity to be transmitted. The base station or the base station control server assigns one entity to one position in the request, assigns bandwidth for radio communication based on the request, and notifies the route assignment server of the assignment result.

The route assignment server estimates the road environment at the time of traveling based on the weather information and the environmental information, estimates the accuracy of the travel control of the vehicle based on the road environment, the measurement information of the vehicle, and the vehicle information, and estimates the occupied area of the vehicle based on the accuracy.

The route assignment server estimates the road environment at the time of traveling based on the weather information and the environmental information, estimates the accuracy of the position measurement of the vehicle based on the road environment, the measurement information of the vehicle, and the vehicle information, and estimates the occupied area of the vehicle based on the accuracy.

The route assignment server estimates the road environment at the time of travel based on the weather information and the environmental information, estimates the road safety degree based on the road environment, and performs assignment of the road area of the vehicle if it is determined that there is a road of which the safety degree has changed.

The route assignment server estimates the road environment at the time of traveling based on the weather information and the environmental information, and estimates the road safety degree based on the road environment. If it is determined that it is necessary to lower the priority of the vehicle based on the safety degree, the route assignment server notifies the vehicle of that effect and lowers the priority.

The route assignment server monitors the road surface condition based on the environmental information and assigns the road area to the vehicle so that the road surface becomes flat.

The route assignment server monitors the road surface condition based on the environmental information and removes the damaged portion of the road surface from the assignment of the road area to the vehicle.

If it is determined that there is a possibility that the positional accuracy will be deteriorated in some vehicles, based on the weather information and the environmental information, the route assignment server selects and instructs the vehicle which is the reference of the position measurement in the area determined as having the possibility of deterioration.

The vehicle as the reference for the position measurement is selected based on the distribution of the vehicle based on the route assignment and the accuracy of the vehicle position detection based on the vehicle information.

The vehicle calculates the position of the vehicle based on the auxiliary position information from the vehicle which is the reference of the position measurement and the measurement value obtained by measuring the position of the reference vehicle by measurement of the vehicle.

The auxiliary position information includes an identifier of the vehicle, a measurement time, a measured position, and a measurement error.

If route assignment server determines that there is a possibility of stopping the base station, based on the weather information and the environmental information, the route assignment server selects and instructs a vehicle as a vehicle broadcasting a synchronization signal, among the vehicles associated with the service area of the base station.

The vehicle broadcasting the synchronization signal is selected based on the distribution of the vehicle based on the route assignment and the accuracy of the internal clock of the vehicle based on the vehicle information.

If the vehicle cannot receive the signal from the base station, the vehicle performs automatic driving based on an auxiliary synchronization signal from the vehicle broadcasting the synchronization signal.

If the route assignment server determines that the possibility of blocking the radio communication network, based on the weather information and the environmental information, the route assignment server generates two or more road assignments and notifies the vehicle of the generated road assignments.

The two or more road assignments have route numbers common to the entire vehicles.

If the route assignment server determines that the possibility of blocking the radio communication network, based on the weather information and the environmental information, the route assignment server sets communication means (communication method, communication band, transmission power) based on traveling positions and road assignment of the vehicle to each vehicle and notifies each vehicle.

If the route assignment server determines that the evacuation instruction is made, based on the weather information, the route assignment server sets the evacuation/rescue vehicle for the vehicle existing in the corresponding area and the surrounding area.

If the route assignment server determines that the evacuation instruction is made, based on the weather information, the route assignment server performs processing for checking the target road condition.

If the current route number and the received route number are different when the position information being traffic impossibility and the road number are received, in the route assignment of the vehicle, the vehicle is updated to the route number of the route assignment which does not include the position information being traffic impossibility, and broadcast the impassable position information and the updated route number.

### INDUSTRIAL APPLICABILITY

The present invention is useful in road transportation systems.

1. A server device performing communication with a plurality of vehicles having an automatic driving function through a network, the server device comprising:
a processing unit configured to assign a road area along a traveling route of the vehicle for each predetermined period and for each of the vehicles included in the plurality of vehicles,
wherein the road area is an area to be occupied by the vehicle on a road within the predetermined period, and
the processing unit notifies each of the vehicles of the road area so that each vehicle travels by automatic driving according to the road area assigned to the vehicle.

2. The server device according to claim 1, wherein,
if each of the vehicles has a priority, the processing unit assigns the road area in the order of a vehicle having a higher priority to a vehicle having a lower priority, and
the processing unit performs charging for each of the vehicles according to the priority, based on the assignment result of the road area based on the priority.

3. The server device according to claim 1, wherein
the processing unit acquires, from the vehicle, measurement information obtained by one sensor or a plurality of sensors provided in the vehicle,
the measurement information includes information indicating an occupied area for each height from a road surface,
the occupied area is an area occupied by the vehicle in a space on the road, and
the processing unit assigns the road area to the vehicle based on the measurement information so that the vehicle does not come in contact with another vehicle.

4. The server device according to claim 3, wherein
the processing unit determines whether to continue traveling in the vehicle based on the measurement information, and
if the processing unit determines that the vehicle does not continue traveling, the processing unit performs processing for stopping the vehicle at a predetermined position.

5. The server device according to claim 3, wherein
the processing unit estimates the occupied area when the vehicle travels on the road, based on information about the vehicle and/or information about the road.

6. The server device according to claim 1, wherein
the processing unit acquires, from the vehicle, position information indicating a position of the vehicle and synchronization information indicating synchronization accuracy at the position,
the synchronization accuracy is determined according to a type of a signal source that is a synchronization source and/or reception strength from the signal source, and
the processing unit determines a length of the predetermined period to be applied to each of the vehicles existing at the position and around the position, based on the synchronization accuracy.

7. The server device according to claim 6, wherein
the processing unit notifies the vehicle of information designating the signal source and a correction value for correcting a synchronization timing synchronized with the synchronization source.

8. The server device according to claim 1, wherein
the processing unit assigns the road area to the vehicle, based on at least one of vehicle information indicating a state of the vehicle or components of the vehicle, weather information about weather in the area where the vehicle is located, measurement information obtained by measuring the state of the vehicle by the vehicle, and environmental information obtained by measuring the surroundings of the vehicle by the vehicle.

9. The server device according to claim 8, wherein
the vehicle information includes at least one of a model number, a use start date, a use time, and a repair history of the vehicle or the components of the vehicle.

10. The server device according to claim 8, wherein
the weather information includes at least one of weather forecast, weather warning/caution, typhoon information, flood information, sediment disaster information, tornado information, tsunami information, earthquake information, and eruption information.

11. The server device according to claim 8, wherein
the measurement information includes at least one of a weight, a center of gravity, a balance, an occupied area for each height, and an opened/closed state of a window.

12. The server device according to claim 8, wherein
the environmental information includes information indicating a state of atmosphere and/or a state of a road surface,
the atmospheric state includes at least one of temperature, pressure, humidity, wind direction, wind pressure, rain, snow, hail, and fog, and
the state of the road surface includes at least one of unevenness on the road surface, drying, flooding, snow covering, freezing, falling objects, and breakage.

13. The server device according to claim 8, wherein
the processing unit notifies at least one of the vehicle, a base station, and a base station control device of a radio communication parameter used by the vehicle to notify the server device of the measurement information and/or the environmental information, and position information indicating a position to which the radio communication parameter is to be applied.

14. The server device according to claim 8, wherein
the processing unit estimates a road environment at the time of traveling of the vehicle, based on the weather information and/or the environmental information,
the processing unit estimates a safety degree of the road corresponding to the traveling route based on the road environment, and
the processing unit changes at least one of the traveling routes, the road area, and the priority of the vehicle based on the safety degree.

15. The server device according to claim 8, wherein,
if the processing unit determines that an evacuation instruction is issued based on the weather information, the processing units instructs at least one vehicle existing in a area corresponding to the evacuation instruction and/or surroundings of the area to operate as an evacuation/rescue vehicle.

16. The server device according to claim 8, wherein,
if the processing unit determines that the evacuation instruction is issued based on the weather information, the processing unit performs processing for checking a road condition corresponding to the evacuation instruction.

17. The server device according to claim 8, wherein
the processing unit monitors a road surface condition based on the environmental information, and
the processing unit assigns the road area to the vehicle based on the road surface condition so that the vehicle travels on a flat road surface and/or the vehicle travels avoiding a road damage area.

18. The server device according to claim 8, wherein
the processing unit estimates a road environment at the time of traveling of the vehicle, based on the weather information and/or the environmental information,
the processing unit estimates accuracy of a travel control of the vehicle and/or accuracy of a position measurement of the vehicle based on at least one of the road environment, the measurement information, and the vehicle information, and
the processing unit estimates an occupied area which is an area occupied by the vehicle in the space on the road, based on the estimated accuracy.

19. The server device according to claim 8, wherein,
if the processing unit determines that there is an area where measurement accuracy of the position deteriorates, based on the weather information and/or the environmental information, the processing unit selects a position reference vehicle as a reference of position measurement, and
the processing unit instructs the position reference vehicle to notify auxiliary position information used for position calculation by surrounding vehicles.

20. The server device according to claim 8, wherein,
if the processing unit determines that there is a possibility that a base station serving as a synchronization source will be stopped, based on the weather information and/or the environmental information, the processing unit selects a synchronous reference vehicle from the vehicles related to a service providing area of the base station, and
the processing unit instructs the synchronous reference vehicle to broadcast an auxiliary synchronization signal used for synchronization processing by surrounding vehicles.

21. The server device according to claim 8, wherein,
if the processing unit determines that there is a possibility that a radio communication network will be interrupted, based on the weather information and/or the environmental information, the processing unit previously notifies each of the vehicles of a plurality of traveling routes.

22. The server device according to claim 21, wherein
each of the plurality of traveling routes has a route number common to the entire vehicles.

23. The server device according to claim 8, wherein,
if the processing unit determines that there is a possibility that a radio communication network will be interrupted, based on the weather information and the environmental information, the processing unit previously notifies each of the vehicles of radio communication parameters to be used for each section included in the traveling route.

24. A vehicle control device provided in a vehicle having an automatic driving function and controlling the vehicle, the vehicle control device comprising:
a communication unit configured to perform communication with a server device through a network; and
a processing unit configured to acquire, from the server device, assignment information indicating assignment of a road area along the traveling route of the vehicle,
wherein the road area is an area which is assigned from the server device for each predetermined period and is occupied by the vehicle on the road within the predetermined period, and
the processing unit performs processing for the vehicle to travel through an assigned road area of the vehicle by automatic driving, based on the assignment information.

25. A communication device provided in a vehicle, the communication device comprising:
a communication unit configured to perform communication with a server device through a network,
wherein the communication unit acquires, from the server device, assignment information indicating assignment of a road area along a traveling route of the vehicle, and
the road area is an area which is assigned from the server device for each predetermined period and is occupied by the vehicle on a road within the predetermined period.
